(19) United States
(12) Patent Application Publication
(10) Pub. No.: US 2020/0036102 A1
(43) Pub. Date: Jan. 30, 2020

(54) WAVEGUIDE DEVICE AND ANTENNA DEVICE

(71) Applicant: Nidec Corporation, Kyoto (JP)

(72) Inventors: Hiroyuki KAMO, Kyoto (JP); Hideyuki MUTO, Kyoto (JP); Takumi YAMAGUCHI, Kyoto (JP)

(21) Appl. No.: 16/524,272

(22) Filed: Jul. 29, 2019

(30) Foreign Application Priority Data
Jul. 30, 2018 (JP) 2018-142607

(51) Int. Cl. H01Q 21/00; H01Q 13/02

(52) U.S. Cl. CPC H01Q 21/005; H01Q 13/0233

(57) ABSTRACT

A waveguide device includes a first electrical conductor including a first electrically conductive surface, a second electrical conductor including a second electrically conductive surface opposing the first electrically conductive surface, an electrically-conductive ridge protruding from the second electrically conductive surface, and a plurality of electrically-conductive rods disposed on both sides of the ridge. The plurality of rods include one or more first rods adjoining the ridge. Each first rod includes a first side surface opposing a side surface of the ridge and a second side surface not opposing the side surface of the ridge. The first side surface is flat and perpendicular or substantially perpendicular to the second electrically conductive surface. The second side surface includes a shape that increasingly deviates outward from an axial center of the first rod from the leading end toward the root of the first rod.

### CROSS REFERENCE TO RELATED APPLICATION

The present invention claims priority under 35 U.S.C. § 119 to Japanese Application No. 2018-142607 filed on Jul. 30, 2018, the entire contents of which are hereby incorporated herein by reference.

### 1. FIELD OF THE INVENTION

The present disclosure relates to a waveguide device and an antenna device.

### 2. BACKGROUND

The specification of U.S. Pat. No. 8,779,995, the specification of U.S. Pat. No. 8,803,638, the specification of European Patent Application Publication No. 1331688, the specification of U.S. Pat. No. 10,027,032 and Kirino et al., “A 76 GHz Multi-Layered Phased Array Antenna Using a Non-Metal Contact Metamaterial Waveguide”, IEEE Transaction on Antennas and Propagation, Vol. 60, No. 2, February 2012, pp 840-853 disclose waveguide devices. Each of the waveguide devices disclosed in these publications, as a whole, includes a pair of opposing electrically conductive plates. One of the electrically conductive plates has a ridge that protrudes toward the other electrically conductive plate, and a plurality of electrically conductive rods that are disposed in row and column directions on both sides of the ridge. The plurality of conductive rods constitute an artificial magnetic conductor. Via a gap, the electrically-conductive upper face of the ridge is opposed to the electrically conductive surface of the other electrically conductive plate. An electromagnetic wave having a wavelength that falls within a propagation stop band of the artificial magnetic conductor propagates in a space between this electrically conductive surface and the upper face of the ridge, in a manner of following along the ridge. In the present specification, a waveguide of this kind will be referred to as a WRG (Waffle-iron Ridge waveguide) or a WRG waveguide. A WRG waveguide may be used, in e.g. an antenna device having one or more slots as a radiating element(s), as a waveguide for feeding the slots.

As is disclosed in the specification of U.S. Pat. No. 10,027,032, for example, the plurality of conductive rods may each take various shapes, e.g., a prismatic shape, a shape obtained by chamfering the corners of a prism, a cylindrical shape, a shape having an increasing width as going from the upper end toward the root (gradually-pointed shape). The specification of U.S. Pat. No. 10,027,032 states in particular that adopting a gradually-pointed shape for rods that are adjacent to a bend or a branching portion of the ridge will allow reflection of signal waves at the bend or branching portion to be suppressed.

### SUMMARY

Example embodiments of the present disclosure provide novel waveguide devices and antenna devices that each reduce the propagation loss of an electromagnetic wave propagating in a waveguide.

A waveguide device according to an aspect of an example embodiment of the present disclosure includes a first electrical conductor including a first electrically conductive surface, a second electrical conductor including a second electrically conductive surface opposing the first electrically conductive surface, an electrically-conductive ridge protruding from the second electrically conductive surface, and a plurality of electrically-conductive rods disposed on both sides of the ridge. The ridge includes a waveguide surface extending opposite to the first electrically conductive surface. Each rod includes a root that is connected to the second electrically conductive surface and a leading end opposing the first electrically conductive surface. A waveguide is defined between the waveguide surface and the first electrically conductive surface. The plurality of rods include one or more first rods adjoining the ridge. Each first rod includes a first side surface opposing a side surface of the ridge and a second side surface not opposing the side surface of the ridge. The first side surface is flat and perpendicular or substantially perpendicular to the second electrically conductive surface. The second side surface has a shape that increasingly deviates outward from an axial center of the first rod from the leading end toward the root of the first rod. A distance from the axial center to the first side surface at the root is smaller than a distance from the axial center to the second side surface at the root.

A waveguide device according to another aspect of an example embodiment of the present disclosure includes a first electrical conductor including a first electrically conductive surface, a second electrical conductor including a second electrically conductive surface opposing the first electrically conductive surface and a waveguide defining and functioning as a throughhole, and a plurality of electrically-conductive rods. Each rod includes a root that is connected to the second electrically conductive surface and a leading end opposing the first electrically conductive surface. The plurality of rods include one or more rods adjoining the throughhole. Each of the one or more rods includes a first side surface located on the throughhole side and a second side surface distinct from the first side surface. The first side surface is flat and substantially orthogonal to the second electrically conductive surface. The second side surface has a shape that increasingly deviates outward from an axial center of the rod as going from the leading end toward the root of the rod.

According to example embodiments of the present disclosure, the propagation loss of an electromagnetic wave propagating in a waveguide is able to be reduced.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view schematically showing an example of a waveguide device according to an example embodiment of the present disclosure.

FIG. 2A is a diagram schematically showing an exemplary cross-sectional construction of the waveguide device as taken parallel to the XZ plane.

FIG. 2B is a diagram schematically showing another exemplary cross-sectional construction of the waveguide device as taken parallel to the XZ plane.

FIG. 3 is a perspective view schematically showing the waveguide device, illustrated so that the spacing between a first conductive member and a second conductive member is exaggerated.

FIG. 4 is a diagram showing an exemplary range of dimension of each member in the structure shown in FIG. 2A.

FIG. 5A is a cross-sectional view showing another waveguide device according to another example embodiment of the present disclosure.

FIG. 5B is a cross-sectional view showing still another waveguide device according to another example embodiment of the present disclosure.

FIG. 5C is a cross-sectional view showing still another waveguide device according to another example embodiment of the present disclosure.

FIG. 5D is a cross-sectional view showing still another waveguide device according to another example embodiment of the present disclosure.

FIG. 5E is a cross-sectional view showing still another waveguide device according to another example embodiment of the present disclosure.

FIG. 5F is a cross-sectional view showing still another waveguide device according to another example embodiment of the present disclosure.

FIG. 5G is a cross-sectional view showing still another waveguide device according to another example embodiment of the present disclosure.

FIG. 6A is a cross-sectional view showing still another waveguide device according to another example embodiment of the present disclosure.

FIG. 6B is a cross-sectional view showing still another waveguide device according to another example embodiment of the present disclosure.

FIG. 7A is a diagram schematically showing an electromagnetic wave propagating between a waveguide surface of a waveguide and a conductive surface of a conductor.

FIG. 7B is a diagram schematically showing a cross section of a hollow waveguide.

FIG. 7C is a cross-sectional view showing an implementation where two waveguide members are provided on the conductor.

FIG. 7D is a diagram schematically showing a cross section of a waveguide device in which two hollow waveguides are placed side-by-side.

FIG. 8A is a perspective view schematically showing a partial construction of an antenna device.

FIG. 8B is a diagram schematically showing a cross section of the antenna device.

FIG. 9 is a perspective view showing a portion of a waveguide device according to a first example embodiment of the present disclosure.

FIG. 10 is a plan view showing a portion of the waveguide device according to the first example embodiment of the present disclosure.

FIG. 11 is a cross-sectional view showing a portion of the waveguide device according to the first example embodiment of the present disclosure.

FIG. 12 is a diagram showing enlarged a portion of the waveguide device according to the first example embodiment of the present disclosure.

FIG. 13A is a diagram showing a first example of a cross-sectional shape of a rod.

FIG. 13B is a diagram showing a second example of a cross-sectional shape of a rod.

FIG. 13C is a diagram showing a third example of a cross-sectional shape of a rod.

FIG. 14 is a cross-sectional view showing a portion of a waveguide device according to a variant of the first example embodiment of the present disclosure.

FIG. 15 is a diagram showing a portion of a waveguide device according to another variant of the first example embodiment of the present disclosure.

FIG. 16 is a diagram showing a portion of a waveguide device according to a second example embodiment of the present disclosure.

FIG. 17 is a diagram showing a portion of a waveguide device according to a variant of the second example embodiment of the present disclosure.

FIG. 18A is a perspective view schematically showing a portion of a waveguide device according to a third example embodiment of the present disclosure.

FIG. 18B is a perspective view schematically showing a first conductive member according to the third example embodiment of the present disclosure.

FIG. 18C is a perspective view schematically showing a second conductive member according to the third example embodiment of the present disclosure.

FIG. 19A is a cross-sectional view schematically showing a portion of the waveguide device according to the third example embodiment of the present disclosure.

FIG. 19B is a cross-sectional view schematically showing a portion of a waveguide device according to a variant of the third example embodiment of the present disclosure.

FIG. 19C is a cross-sectional view schematically showing a portion of a waveguide device according to another variant of the third example embodiment of the present disclosure.

FIG. 20A is a perspective view schematically showing a first conductive member according to a variant of the third example embodiment of the present disclosure.

FIG. 20B is a perspective view schematically showing a second conductive member according to the variant of the third example embodiment of the present disclosure.

FIG. 21A is a cross-sectional view schematically showing a portion of the waveguide device according to the variant of the third example embodiment of the present disclosure.

FIG. 21B is a cross-sectional view schematically showing a portion of a waveguide device according to another variant of the third example embodiment of the present disclosure.

FIG. 21C is a cross-sectional view schematically showing a portion of a waveguide device according to still another variant of the third example embodiment of the present disclosure.

FIG. 22A is a plan view schematically showing an antenna device according to a fourth example embodiment of the present disclosure.

FIG. 22B is a cross-sectional view taken along line B-B in FIG. 22A.

FIG. 23A is a diagram showing the structure on a first conductive member according to the fourth example embodiment of the present disclosure.

FIG. 23B is a diagram showing the structure on a second conductive member according to the fourth example embodiment of the present disclosure.

FIG. 23C is a diagram showing the structure on a third conductive member according to the fourth example embodiment of the present disclosure.

FIG. 24A is a perspective view showing one radiating element of a slot antenna device according to still another variant of an example embodiment of the present disclosure.

FIG. 24B is a diagram illustrated so that, in the radiating element of FIG. 24A, the spacing between a conductive member 110 and another conductive member 160 is exaggerated.

FIG. 25 is a diagram showing variations of throughholes.

### DETAILED DESCRIPTION

A waveguide device according to an example embodiment of the present disclosure includes a first electrical conductor including a first electrically conductive surface, a second electrical conductor including a second electrically conductive surface opposing the first electrically conductive surface, an electrically-conductive ridge protruding from the second electrically conductive surface, and a plurality of electrically-conductive rods disposed on both sides of the ridge. The ridge includes a waveguide surface extending opposite to the first electrically conductive surface. Each rod includes a root that is connected to the second electrically conductive surface and a leading end opposing the first electrically conductive surface. A waveguide is defined between the waveguide surface and the first electrically conductive surface. The plurality of rods include one or more first rods adjoining the ridge. Each first rod includes a first side surface opposing a side surface of the ridge and a second side surface not opposing the side surface of the ridge. The first side surface is flat and perpendicular or substantially perpendicular to the second electrically conductive surface. The second side surface has a shape that increasingly deviates outward from an axial center of the first rod from the leading end toward the root of the first rod. A distance from the axial center to the first side surface at the root is smaller than a distance from the axial center to the second side surface at the root.

In accordance with the construction, energy losses of an electromagnetic wave propagating along the ridge can be suppressed. Furthermore, as will be described later, the amount of work associated with the simulations to be performed when designing the waveguide device can also be reduced. As a result, a waveguide device and antenna device having the desired performance can be promptly designed.

In the present specification, to be “substantially orthogonal” does not necessarily mean being strictly orthogonal, but means intersecting at 90 degrees or an angle that is close to 90 degrees. When intersection occurs at an angle which is within the range of not less than 80 degrees and not more than 100 degrees (i.e., 90°±100°), it falls within the meaning of being “substantially orthogonal”. As the intersecting angle becomes closer to 90 degrees, the amount of work associated with model generation on a CAD system (Computer-aided design system), etc., to be performed during the design of the waveguide device can be reduced. In one example embodiment, the intersecting angle between the first side face of each rod and the second electrically conductive surface is set to be not less than 85 degrees and not more than 95 degrees. Similarly, the expression “substantially perpendicular” does not necessarily mean being strictly perpendicular, but means either being perpendicular or being of an angular relationship that is close to perpendicular. Any angular relationship falling within ±10° of perpendicularity satisfies being “substantially perpendicular”. Note that, whenever just saying “orthogonal” or “perpendicular”, without the additional modifier “substantially”, strict orthogonality or perpendicularity is actually meant.

The “axial center” of a rod refers to an axis that passes through the centroid of the rod and extends along the normal direction of the second electrically conductive surface. Each rod may have a symmetric shape with respect to its axial center, or an asymmetric shape with respect to its axial center.

In accordance with the above construction, the angle of inclination of at least a portion of the second side face of the first rod(s) relative to the normal of the second electrically conductive surface is greater than the angle of inclination of the first side face of the first rod(s) relative to the normal of the second electrically conductive surface. All side faces of the first rod(s) other than the first side face may, similarly to the second side face, have a shape that increasingly deviates outward from the axial center of the first rod(s) as going from the leading end toward the root of the first rod(s). With such structure, not only propagation losses are reduced, but also it becomes easy to apply a mass-production technique using a template, e.g., a die-casting method. When a member composing an antenna device according to the present disclosure is produced by a die-casting method, it is more preferable that a face that is substantially orthogonal to the second electrically conductive surface, such as the aforementioned first side face, is sloped by e.g. 0.5 degrees relative to the second electrically conductive surface. In this case, the first side face will also have a shape that increasingly deviates from the axial center toward the root of the rod. Also in that case, however, the distance from the axial center to the first side face at the root is smaller than the distance from the axial center to the second side face at the root.

The ridge may include at least one of a bend and a branching portion. The first side face of at least one of the one or more first rods may be opposed to a side face of the ridge at the bend or the branching portion.

At a bend or a branching portion, a change occurs in the direction that the ridge extends. In such a portion where a change occurs in the direction that the ridge extends, impedance mismatching might otherwise occur to cause an unwanted reflection of the propagating electromagnetic wave; by adopting the aforementioned shape for the side face of the first rod that adjoins a bend or branching portion, however, it becomes possible to suppress unwanted reflection at the bend or branching portion. Furthermore, a more prompt design of the device can be made as compared to the rod structure in the specification of U.S. Pat. No. 10,027,032.

The second electrically conductive member may have a throughhole leading to the waveguide defined between the waveguide face and the first electrically conductive surface. The plurality of rods may include one or more second rods adjoining the throughhole. In this case, each second rod has a first side face located on the throughhole side and a second side face distinct from the first side face. In each second rod, the first side face is flat and substantially orthogonal to the second electrically conductive surface. The second side face has a shape that increasingly deviates outward from an axial center of the second rod as going from the leading end toward the root of the second rod. A distance from the axial center to the first side face at the root is smaller than a distance from the axial center to the second side face at the root.

The throughhole may function as a hollow waveguide. This hollow waveguide is connected to a WRG waveguide extending between the waveguide face and the first electrically conductive surface. With the above structure, in addition to the aforementioned effects, energy losses of an electromagnetic wave propagating between the throughhole and the WRG waveguide can be reduced.

The angle of inclination of at least a portion of the second side face of the second rod(s) relative to the normal of the second electrically conductive surface is greater than the angle of inclination of the first side face of the second rod(s) relative to the normal of the second electrically conductive surface. All side faces of the second rod(s) other than the first side face may, similarly to the second side face, have a shape that increasingly deviates outward from the axial center of the second rod(s) as going from the leading end toward the root of the second rod(s). With such structure, not only propagation losses are reduced, but also it becomes easy to apply a mass-production technique using a template, e.g., a die-casting method.

The plurality of rods may include one or more third rods adjoining both of the ridge and the throughhole. In this case, each third rod has a first side face opposing a side face of the ridge, a second side face located on the throughhole side, and a third side face distinct from the first side face and the second side face. In each third rod, each of the first side face and the second side face is flat and substantially orthogonal to the second electrically conductive surface. The third side face has a shape that increasingly deviates outward from an axial center of the third rod as going from the leading end toward the root of the third rod. A distance from the axial center to the first side face at the root is smaller than a distance from the axial center to the third side face at the root.

The angle of inclination of at least a portion of the third side face of the third rod(s) relative to the normal of the second electrically conductive surface is greater than the angle of inclination of each of the first side face and the second side face of the third rod(s) relative to the normal of the second electrically conductive surface. All side faces of the third rod(s) other than the first side face and the second side face may, similarly to the third side face, have a shape that increasingly deviates outward from the axial center of the third rod(s) as going from the leading end toward the root of the third rod(s).

When the ridge is regarded as a first ridge, the waveguide device may further comprise an electrically-conductive second ridge located at a gap from the first ridge. The second ridge protrudes from the second electrically conductive surface and has a waveguide face which extends in opposition to the first electrically conductive surface. A waveguide is defined between the waveguide face and the first electrically conductive surface. The plurality of rods may include one or more rod rows located between the first ridge and the second ridge. In this case, at least one rod included in the rod row has a first side face opposing a side face of the first ridge or the second ridge and a second side face opposing neither the side face of the first ridge nor the side face of the second ridge. The first side face is flat and substantially orthogonal to the second electrically conductive surface. The second side face has a shape that increasingly deviates outward from an axial center of the rod as going from the leading end toward the root of the rod.

The one or more rod rows located between the first ridge and the second ridge may consist of one rod row. In this case, regarding side faces of each rod in the rod row, a side face opposing the side face of the first ridge and a side face opposing the side face of the second ridge are each flat and substantially orthogonal to the second electrically conductive surface. Any other side face has a shape that increasingly deviates outward from the axial center of the rod as going from the leading end toward the root of the rod.

A waveguide device according to another example embodiment of the present disclosure comprises: a first electrically conductive member having a first electrically conductive surface; a second electrically conductive member having a second electrically conductive surface opposing the first electrically conductive surface and a waveguide functioning as a throughhole; and a plurality of electrically-conductive rods. Each rod has a root that is connected to the second electrically conductive surface and a leading end opposing the first electrically conductive surface. The plurality of rods include one or more rods adjoining the throughhole. Each of the one or more rods has a first side face located on the throughhole side and a second side face distinct from the first side face. The first side face is flat and substantially orthogonal to the second electrically conductive surface. The second side face has a shape that increasingly deviates outward from an axial center of the rod as going from the leading end toward the root of the rod.

The throughhole may function as a hollow waveguide. In accordance with the above structure, energy losses of an electromagnetic wave propagating through the throughhole can be reduced. Moreover, by ensuring that the first side face that faces toward the throughhole is substantially orthogonal to the second electrically conductive surface, a prompt design is enabled.

The angle of inclination of at least a portion of the second side face of the one or more rods relative to the normal of the second electrically conductive surface is greater than the angle of inclination of the first side face of the rod(s) relative to the normal of the second electrically conductive surface. All side faces of the rod(s) other than the first side face may, similarly to the second side face, have a shape that increasingly deviates outward from the axial center of the rod(s) as going from the leading end toward the root of the rod(s).

In each of the above implementations, at least a portion of the second electrically conductive member, the ridge, and the plurality of rods may comprise: a dielectric member that defines a shape of the at least portion of the second electrically conductive member, the ridge, and the plurality of rods; and a layer of electrically conductive material covering a surface of the member. The plurality of rods may have an electrically-conductive plating layer on the surface of the plurality of rods. Similarly, the ridge may also have an electrically-conductive plating layer on the surface of the ridge. In this case, a plating layer is formed on the surface of the dielectric member defining the shape of the second electrically conductive member, the ridge, and the rods. It is not necessary for the entirety of the second electrically conductive member, the ridge, and the rods to have their shape defined by the dielectric member. The shape of a portion of the second electrically conductive member, the ridge, and the rods may be directly defined by e.g. a metal member. Furthermore, instead of a plating layer, a layer of electrically conductive material may be formed by vapor deposition or the like. The second electrically conductive member, the ridge, and the rods may be produced by a metal machine of casting, forging, or the like. Each of the second electrically conductive member, the ridge, and the rods may be a portion of a single-piece body.

The above-described waveguide device may be used for an antenna device, for example. The antenna device would comprise: a waveguide device according to an example embodiment of the present disclosure; and one or more antenna elements connected to the waveguide device.

The first electrically conductive member may have at least one slot that is opposed to the waveguide face of the ridge or the throughhole. Such a slot may function as the antenna element. In the present disclosure, a slot that is made in the first electrically conductive member is regarded also as an “antenna element that is connected to the waveguide device”.

The antenna device may be an antenna array having a plurality of antenna elements. The plurality of antenna elements may be arranged in a one-dimensional or two-dimensional array.

### <Outline of WRG Structure>

Prior to describing specific example embodiments of the present disclosure, a WRG structure for use in example embodiments of the present disclosure will be described.

FIG. 1 shows XYZ coordinates along X, Y and Z directions which are orthogonal to one another. The waveguide device 100 shown in the figure includes a plate-like (plate-shaped) first electrically conductive member 110 and a plate-like (plate-shaped) second electrically conductive member 120, which are in opposing and parallel positions to each other. A plurality of electrically conductive rods 124 are arrayed on the second conductive member 120.

Note that any structure appearing in a figure of the present application is shown in an orientation that is selected for ease of explanation, which in no way should limit its orientation when an example embodiment of the present disclosure is actually practiced. Moreover, the shape and size of a whole or a part of any structure that is shown in a figure should not limit its actual shape and size.

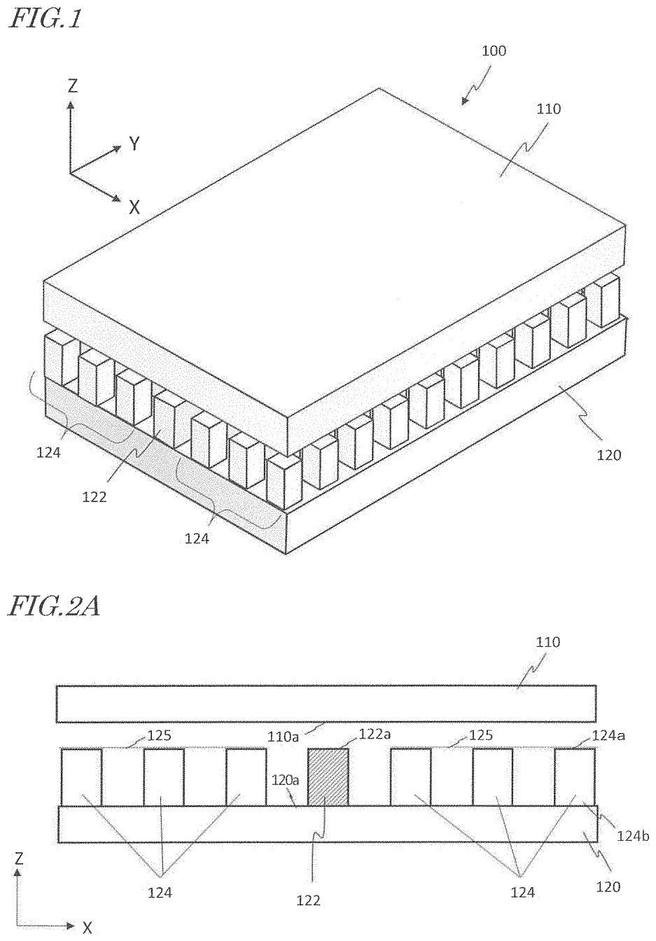

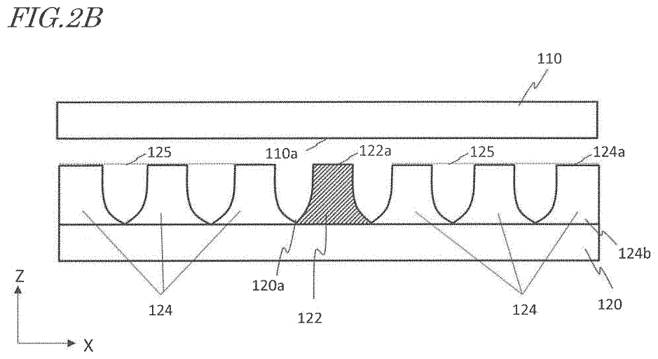

As shown in FIG. 2A, the first conductive member 110 has an electrically conductive surface 110a on the side facing the second conductive member 120. The conductive surface 110a has a two-dimensional expanse along a plane which is orthogonal to the axial direction (i.e., the Z direction) of the conductive rods 124 (i.e., a plane which is parallel to the XY plane). Although the conductive surface 110a is shown to be a smooth plane in this example, the conductive surface 110a does not need to be a plane, as will be described later.

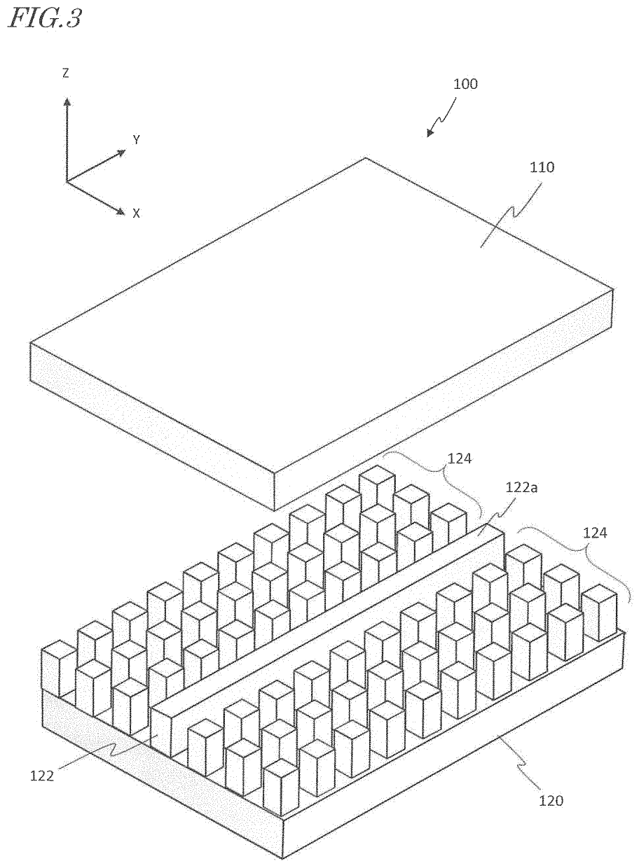

FIG. 3 is a perspective view schematically showing the waveguide device 100, illustrated so that the spacing between the first conductive member 110 and the second conductive member 120 is exaggerated for ease of understanding. In an actual waveguide device 100, as shown in FIG. 1 and FIG. 2A, the spacing between the first conductive member 110 and the second conductive member 120 is narrow, with the first conductive member 110 covering over all of the conductive rods 124 on the second conductive member 120.

FIG. 1 to FIG. 3 only show portions of the waveguide device 100. The conductive members 110 and 120, the waveguide member 122, and the plurality of conductive rods 124 actually extend to outside of the portions illustrated in the figures. At an end of the waveguide member 122, as will be described later, a choke structure for preventing electromagnetic waves from leaking into the external space is provided. The choke structure may include a row of conductive rods that are adjacent to the end of the waveguide member 122, for example.

See FIG. 2A again. The plurality of conductive rods 124 arrayed on the second conductive member 120 each have a leading end 124a opposing the conductive surface 110a. In the example shown in the figure, the leading ends 124a of the plurality of conductive rods 124 are on the same plane. This plane defines the surface 125 of an artificial magnetic conductor. Each conductive rod 124 does not need to be entirely electrically conductive, so long as at least the surface (the upper face and the side faces) of the rod-like structure) is electrically conductive. Moreover, each second conductive member 120 does not need to be entirely electrically conductive, so long as it can support the plurality of conductive rods 124 to constitute an artificial magnetic conductor. Of the surfaces of the second conductive member 120, a face carrying the plurality of conductive rods 124 may be electrically conductive, such that the electrical conductor electrically interconnects the surfaces of adjacent ones of the plurality of conductive rods 124. In other words, the entire combination of the second conductive member 120 and the plurality of conductive rods 124 may at least include an electrically conductive surface with rises and falls opposing the conductive surface 110a of the first conductive member 110.

On the second conductive member 120, a ridge-like waveguide member 122 is provided among the plurality of conductive rods 124. More specifically, stretches of an artificial magnetic conductor are present on both sides of the waveguide member 122, such that the waveguide member 122 is sandwiched between the stretches of artificial magnetic conductor on both sides. As can be seen from FIG. 3, the waveguide member 122 in this example is supported on the second conductive member 120, and extends linearly along the Y direction. In the example shown in the figure, the waveguide member 122 has the same height and width as those of the conductive rods 124. As will be described later, however, the height and width of the waveguide member 122 may have respectively different values from those of the conductive rod 124. Unlike the conductive rods 124, the waveguide member 122 extends along a direction (which in this example is the Y direction) in which to guide electromagnetic waves along the conductive surface 110a. Similarly, the waveguide member 122 does not need to be entirely electrically conductive, but may at least include an electrically conductive waveguide face 122a opposing the conductive surface 110a of the first conductive member 110. The second conductive member 120, the plurality of conductive rods 124, and the waveguide member 122 may be portions of a continuous single-piece body. Furthermore, the first conductive member 110 may also be a portion of such a single-piece body.

On both sides of the waveguide member 122, the space between the surface 125 of each stretch of artificial magnetic conductor and the conductive surface 110a of the first conductive member 110 does not allow an electromagnetic wave of any frequency that is within a specific frequency band to propagate. This frequency band is called a “prohibited band”. The artificial magnetic conductor is designed so that the frequency of a signal wave to propagate in the waveguide device 100 (which may hereinafter be referred to as the “operating frequency”) is contained in the prohibited band. The prohibited band may be adjusted based on the following: the height of the conductive rods 124, i.e., the depth of each groove formed between adjacent conductive rods 124; the diameter of each conductive rod 124; the interval between conductive rods 124; and the size of the gap between the leading end 124a and the conductive surface 110a of each conductive rod 124.

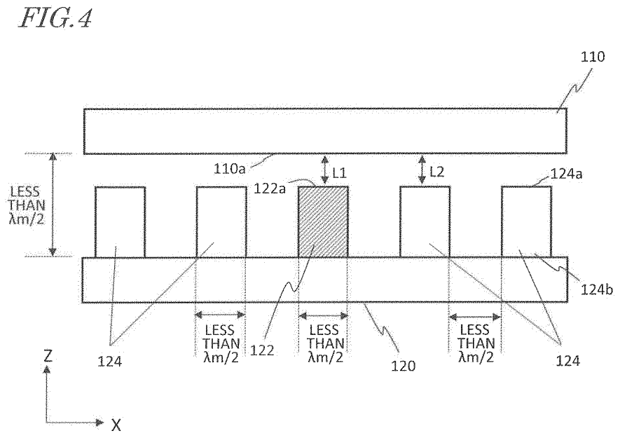

Next, with reference to FIG. 4, the dimensions, shape, positioning, and the like of each member in the structure shown in FIG. 2A will be described. The waveguide device is used for at least one of transmission and reception of electromagnetic waves of a predetermined band (referred to as the “operating frequency band”). In the present specification, λo denotes a representative value of wavelengths in free space (e.g., a central wavelength corresponding to a center frequency in the operating frequency band) of an electromagnetic wave (signal wave) propagating in a waveguide extending between the conductive surface 110a of the first conductive member 110 and the waveguide face 122a of the waveguide member 122. Moreover, Am denotes a wavelength, in free space, of an electromagnetic wave of the highest frequency in the operating frequency band. The end of each conductive rod 124 that is in contact with the second conductive member 120 is referred to as the “root”. As shown in FIG. 4, each conductive rod 124 has the leading end 124a and the root 124b. Examples of dimensions, shapes, positioning, and the like of the respective members are as follows.

### (1) Width of the Conductive Rod

The width (i.e., the size along the X direction and the Y direction) of the conductive rod 124 may be set to less than λm/2. Within this range, resonance of the lowest order can be prevented from occurring along the X direction and the Y direction. Since resonance may possibly occur not only in the X and Y directions but also in any diagonal direction in an X-Y cross section, the diagonal length of an X-Y cross section of the conductive rod 124 is also preferably less than λm/2. The lower limit values for the rod width and diagonal length will conform to the minimum lengths that are producible under the given manufacturing method, but is not particularly limited.

(2) Distance from the Root of the Conductive Rod to the Conductive Surface of the First Conductive Member 110

The distance from the root 124b of each conductive rod 124 to the conductive surface 110a of the first conductive member 110 may be longer than the height of the conductive rods 124, while also being less than λm/2. When the distance is λm/2 or more, resonance may occur between the root 124b of each conductive rod 124 and the conductive surface 110a, thus reducing the effect of signal wave containment.

The distance from the root 124b of each conductive rod 124 to the conductive surface 110a of the first conductive member 110 corresponds to the spacing between the first conductive member 110 and the second conductive member 120. For example, when a signal wave of 76.5±0.5 GHz (which belongs to the millimeter band or the extremely high frequency band) propagates in the waveguide, the wavelength of the signal wave is in the range from 3.8934 mm to 3.9446 mm. Therefore, Am equals 3.8934 mm in this case, so that the spacing between the first conductive member 110 and the second conductive member 120 may be set to less than a half of 3.8934 mm. So long as the first conductive member 110 and the second conductive member 120 realize such a narrow spacing while being disposed opposite from each other, the first conductive member 110 and the second conductive member 120 do not need to be strictly parallel. Moreover, when the spacing between the first conductive member 110 and the second conductive member 120 is less than λm/2, a whole or a part of the first conductive member 110 and/or the second conductive member 120 may be shaped as a curved surface. On the other hand, the conductive members 110 and 120 each have a planar shape (i.e., the shape of their region as perpendicularly projected onto the XY plane) and a planar size (i.e., the size of their region as perpendicularly projected onto the XY plane) which may be arbitrarily designed depending on the purpose.

Although the conductive surface 120a is illustrated as a plane in the example shown in FIG. 2A, example embodiments of the present disclosure are not limited thereto. For example, as shown in FIG. 2B, the conductive surface 120a may be the bottom parts of faces each of which has a cross section similar to a U-shape or a V-shape. The conductive surface 120a will have such a structure when each conductive rod 124 or the waveguide member 122 is shaped with a width which increases toward the root. In this example, the waveguide member 122 and each the plurality of conductive rods 124 have slanted side faces at their root. The angle of inclination of the waveguide member 122 and each conductive rod 124 at the top of their side faces is smaller than the angle of inclination at their root. Even with such a structure, the device shown in FIG. 2B can function as the waveguide device according to an example embodiment of the present disclosure so long as the distance between the conductive surface 110a and the conductive surface 120a is less than a half of the wavelength Am.

(3) Distance L2 from the Leading End of the Conductive Rod to the Conductive Surface

The distance L2 from the leading end 124a of each conductive rod 124 to the conductive surface 110a is set to less than λm/2. When the distance is λm/2 or more, a propagation mode where electromagnetic waves reciprocate between the leading end 124a of each conductive rod 124 and the conductive surface 110a may occur, thus no longer being able to contain an electromagnetic wave. Note that, among the plurality of conductive rods 124, at least those which are adjacent to the waveguide member 122 do not have their leading ends in electrical contact with the conductive surface 110a. As used herein, the leading end of a conductive rod not being in electrical contact with the conductive surface means either of the following states: there being an air gap between the leading end and the conductive surface; or the leading end of the conductive rod and the conductive surface adjoining each other via an insulating layer which may exist in the leading end of the conductive rod or in the conductive surface.

### (4) Arrangement and Shape of Conductive Rods

The interspace between two adjacent conductive rods 124 among the plurality of conductive rods 124 has a width of less than λm/2, for example. The width of the interspace between any two adjacent conductive rods 124 is defined by the shortest distance from the surface (side face) of one of the two conductive rods 124 to the surface (side face) of the other. This width of the interspace between rods is to be determined so that resonance of the lowest order will not occur in the regions between rods. The conditions under which resonance will occur are determined based by a combination of: the height of the conductive rods 124; the distance between any two adjacent conductive rods; and the capacitance of the air gap between the leading end 124a of each conductive rod 124 and the conductive surface 110a. Therefore, the width of the interspace between rods may be appropriately determined depending on other design parameters. Although there is no clear lower limit to the width of the interspace between rods, for manufacturing ease, it may be e.g. Am/16 or more when an electromagnetic wave in the extremely high frequency range is to be propagated. Note that the interspace does not need to have a constant width. So long as it remains less than λm/2, the interspace between conductive rods 124 may vary.

The arrangement of the plurality of conductive rods 124 is not limited to the illustrated example, so long as it exhibits a function of an artificial magnetic conductor. The plurality of conductive rods 124 do not need to be arranged in orthogonal rows and columns; the rows and columns may be intersecting at angles other than 90 degrees. The plurality of conductive rods 124 do not need to form a linear array along rows or columns, but may be in a dispersed arrangement which does not present any straightforward regularity. The conductive rods 124 may also vary in shape and size depending on the position on the second conductive member 120.

The surface 125 of the artificial magnetic conductor that are constituted by the leading ends 124a of the plurality of conductive rods 124 does not need to be a strict plane, but may be a plane with minute rises and falls, or even a curved surface. In other words, the conductive rods 124 do not need to be of uniform height, but rather the conductive rods 124 may be diverse so long as the array of conductive rods 124 is able to function as an artificial magnetic conductor.

Each conductive rod 124 does not need to have a prismatic shape as shown in the figure, but may have a cylindrical shape, for example. Furthermore, each conductive rod 124 does not need to have a simple columnar shape. The artificial magnetic conductor may also be realized by any structure other than an array of conductive rods 124, and various artificial magnetic conductors are applicable to the waveguide device of the present disclosure. Note that, when the leading end 124a of each conductive rod 124 has a prismatic shape, its diagonal length is preferably less than λm/2. When the leading end 124a of each conductive rod 124 is shaped as an ellipse, the length of its major axis is preferably less than λm/2. Even when the leading end 124a has any other shape, the dimension across it is preferably less than λm/2 even at the longest position.

The height of each conductive rod 124 (in particular, those conductive rods 124 which are adjacent to the waveguide member 122), i.e., the length from the root 124b to the leading end 124a, may be set to a value which is shorter than the distance (i.e., less than λm/2) between the conductive surface 110a and the conductive surface 120a, e.g., λo/4.

### (5) Width of the Waveguide Face

The width of the waveguide face 122a of the waveguide member 122, i.e., the size of the waveguide face 122a along a direction which is orthogonal to the direction that the waveguide member 122 extends, may be set to less than λm/2 (e.g. λo/8). If the width of the waveguide face 122a is λm/2 or more, resonance will occur along the width direction, which will prevent any WRG from operating as a simple transmission line.

### (6) Height of the Waveguide Member

The height (i.e., the size along the Z direction in the example shown in the figure) of the waveguide member 122 is set to less than λm/2. The reason is that, if the distance is λm/2 or more, the distance between the root 124b of each conductive rod 124 and the conductive surface 110a will be λm/2 or more. Similarly, the height of each conductive rod 124 (in particular, those conductive rods 124 which are adjacent to the waveguide member 122) is also set to less than λm/2.

### (7) Distance L1 Between the Waveguide Face and the Conductive Surface

The distance L1 between the waveguide face 122a of the waveguide member 122 and the conductive surface 110a is set to less than λm/2. If the distance is λm/2 or more, resonance will occur between the waveguide face 122a and the conductive surface 110a, which will prevent functionality as a waveguide. In one example, the distance is Am/4 or less. In order to ensure manufacturing ease, when an electromagnetic wave in the extremely high frequency range is to propagate, the distance is preferably Am/16 or more, for example.

The lower limit of the distance L1 between the conductive surface 110a and the waveguide face 122a and the lower limit of the distance L2 between the conductive surface 110a and the leading end 124a of each rod 124 depends on the machining precision, and also on the precision when assembling the two upper/lower conductive members 110 and 120 so as to be apart by a constant distance. When a pressing technique or an injection technique is used, the practical lower limit of the aforementioned distance is about 50 micrometers (μm). In the case of using an MEMS (Micro-Electro-Mechanical System) to make a product in e.g. the terahertz range, the lower limit of the aforementioned distance is about 2 to about 3 μm.

Next, variants of waveguide structures including the waveguide member 122, the conductive members 110 and 120, and the plurality of conductive rods 124 will be described. The following variants are applicable to the WRG structure in any place in each example embodiment described below.

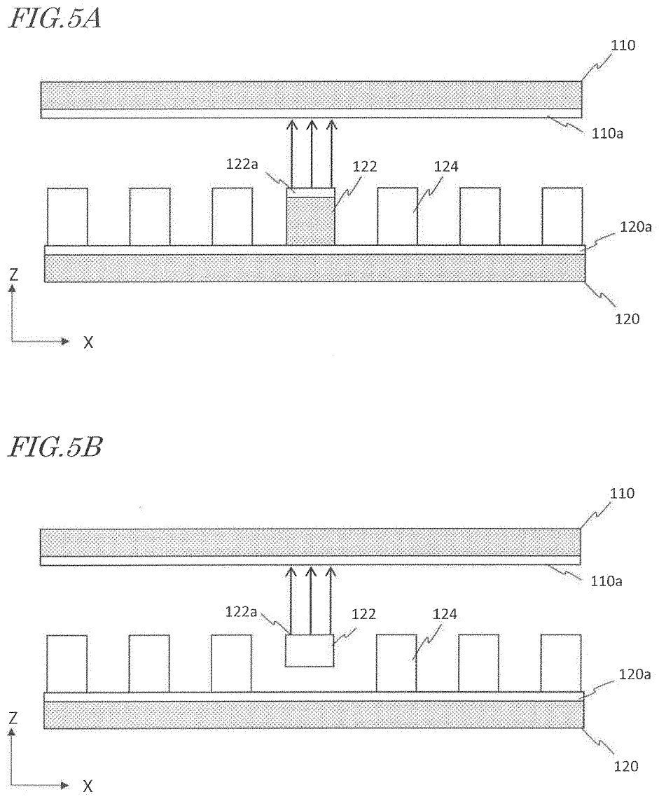

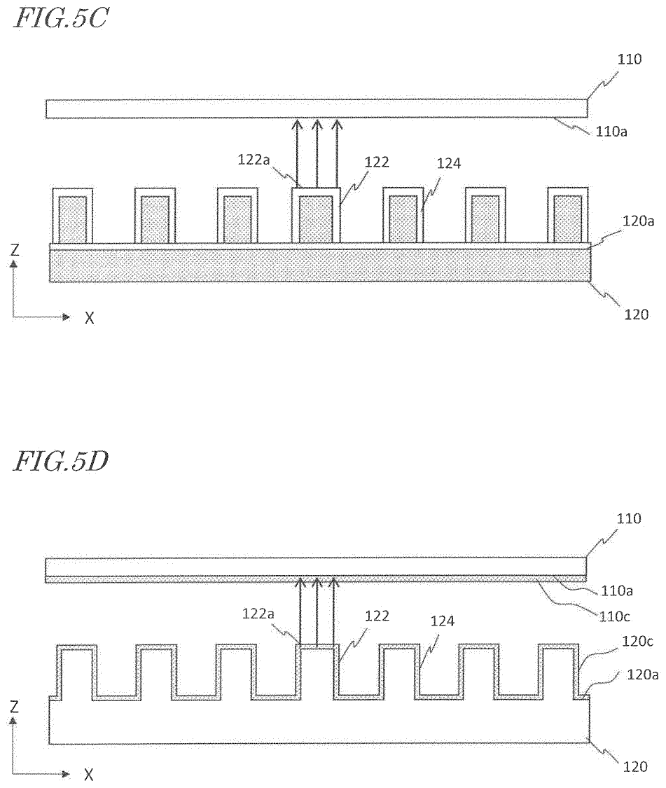

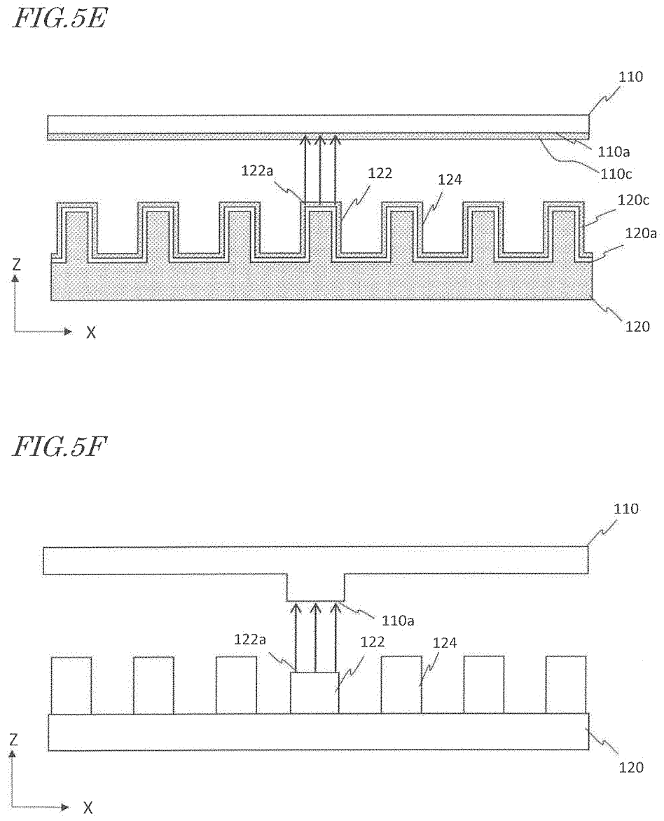

FIG. 5A is a cross-sectional view showing an exemplary structure in which only the waveguide face 122a, defining an upper face of the waveguide member 122, is electrically conductive, while any portion of the waveguide member 122 other than the waveguide face 122a is not electrically conductive. Both of the conductive member 110 and the conductive member 120 alike are only electrically conductive at their surface that has the waveguide member 122 provided thereon (i.e., the conductive surface 110a, 120a), while not being electrically conductive in any other portions. Thus, each of the waveguide member 122, the conductive member 110, and the conductive member 120 does not need to be electrically conductive.

FIG. 5B is a diagram showing a variant in which the waveguide member 122 is not formed on the conductive member 120. In this example, the waveguide member 122 is fixed to a supporting member (e.g., the inner wall of the housing) that supports the conductive members 110 and 120. A gap exists between the waveguide member 122 and the conductive member 120. Thus, the waveguide member 122 does not need to be connected to the conductive member 120.

FIG. 5C is a diagram showing an exemplary structure where the conductive member 120, the waveguide member 122, and each of the plurality of conductive rods 124 are composed of a dielectric surface that is coated with an electrically conductive material such as a metal. The conductive member 120, the waveguide member 122, and the plurality of conductive rods 124 are connected to one another via the electrical conductor. On the other hand, the conductive member 110 is made of an electrically conductive material such as a metal.

FIG. 5D and FIG. 5E are diagrams each showing an exemplary structure in which dielectric layers 110c and 120c are respectively provided on the outermost surfaces of conductive members 110 and 120, a waveguide member 122, and conductive rods 124. FIG. 5D shows an exemplary structure in which the surface of metal conductive members, which are electrical conductors, are covered with a dielectric layer. FIG. 5E shows an example where the conductive member 120 is structured so that the surface of members which are composed of a dielectric, e.g., resin, is covered with an electrical conductor such as a metal, this metal layer being further coated with a dielectric layer. The dielectric layer that covers the metal surface may be a coating of resin or the like, or an oxide film of passivation coating or the like which is generated as the metal becomes oxidized.

The dielectric layer on the outermost surface will allow losses to be increased in the electromagnetic wave propagating through the WRG waveguide, but is able to protect the conductive surfaces 110a and 120a (which are electrically conductive) from corrosion. It also prevents influences of a DC voltage, or an AC voltage of such a low frequency that it is not capable of propagation on certain WRG waveguides.

FIG. 5F is a diagram showing an example where the height of the waveguide member 122 is lower than the height of the conductive rods 124, and the portion of the conductive surface 110a of the conductive member 110 that is opposed to the waveguide face 122a protrudes toward the waveguide member 122. Even such a structure will operate in a similar manner to the above-described construction, so long as the ranges of dimensions depicted in FIG. 4 are satisfied.

FIG. 5G is a diagram showing an example where, further in the structure of FIG. 5F, portions of the conductive surface 110a that oppose the conductive rods 124 protrude toward the conductive rods 124. Even such a structure will operate in a similar manner to the above-described example, so long as the ranges of dimensions depicted in FIG. 4 are satisfied. Instead of a structure in which the conductive surface 110a partially protrudes, a structure in which the conductive surface 110a is partially dented may be adopted.

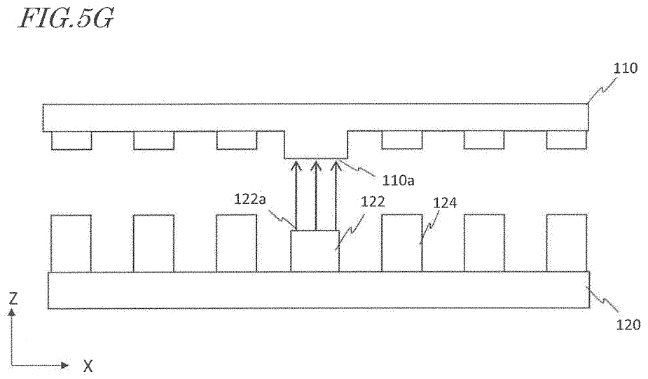

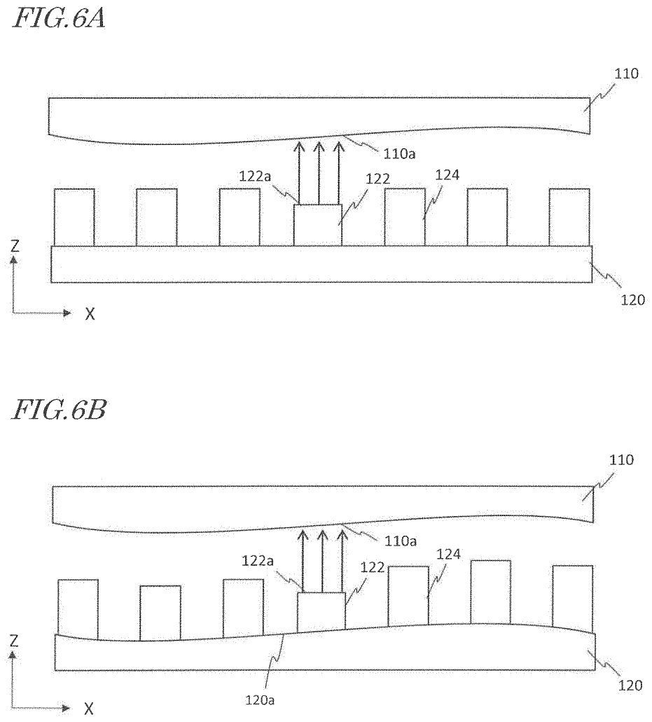

FIG. 6A is a diagram showing an example where a conductive surface 110a of the conductive member 110 is shaped as a curved surface. FIG. 6B is a diagram showing an example where also a conductive surface 120a of the conductive member 120 is shaped as a curved surface. As demonstrated by these examples, the conductive surfaces 110a and 120a may not be shaped as planes, but may be shaped as curved surfaces. A conductive member having a conductive surface which is a curved surface is also qualifies as a conductive member having a “plate shape”.

In the waveguide device 100 of the above-described construction, a signal wave of the operating frequency is unable to propagate in the space between the surface 125 of the artificial magnetic conductor and the conductive surface 110a of the conductive member 110, but propagates in the space between the waveguide face 122a of the waveguide member 122 and the conductive surface 110a of the conductive member 110. Unlike in a hollow waveguide, the width of the waveguide member 122 in such a waveguide structure does not need to be equal to or greater than a half of the wavelength of the electromagnetic wave to propagate. Moreover, the conductive member 110 and the conductive member 120 do not need to be electrically interconnected by a metal wall that extends along the thickness direction (i.e., in parallel to the YZ plane).

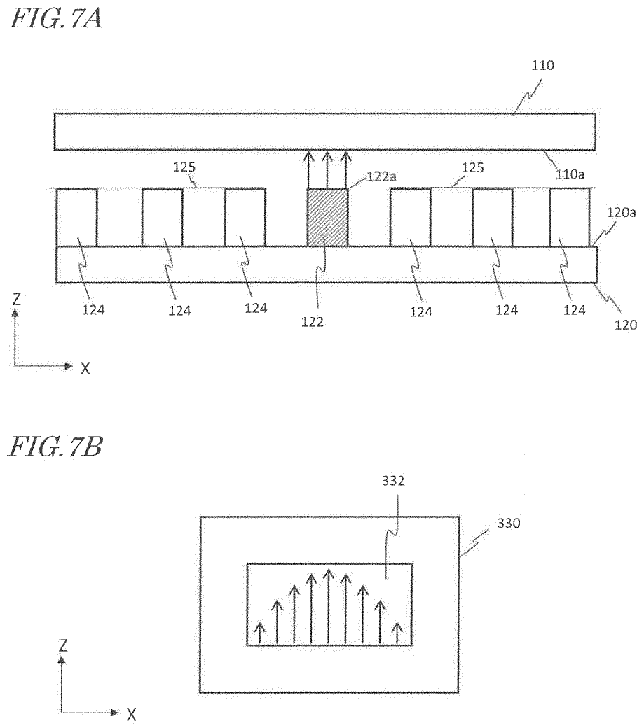

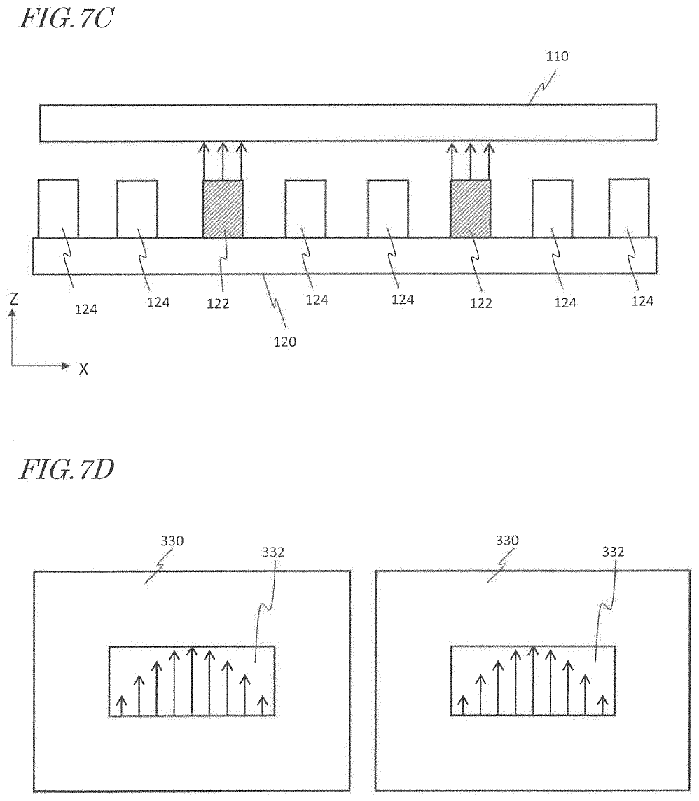

FIG. 7A schematically shows an electromagnetic wave that propagates in a narrow space, i.e., a gap between the waveguide face 122a of the waveguide member 122 and the conductive surface 110a of the conductive member 110. Three arrows in FIG. 7A schematically indicate the orientation of an electric field of the propagating electromagnetic wave. The electric field of the propagating electromagnetic wave is perpendicular to the conductive surface 110a of the conductive member 110 and to the waveguide face 122a.

On both sides of the waveguide member 122, stretches of artificial magnetic conductor that are created by the plurality of conductive rods 124 are present. An electromagnetic wave propagates in the gap between the waveguide face 122a of the waveguide member 122 and the conductive surface 110a of the conductive member 110. FIG. 7A is schematic, and does not accurately represent the magnitude of an electromagnetic field to be actually created by the electromagnetic wave. A part of the electromagnetic wave (electromagnetic field) propagating in the space over the waveguide face 122a may have a lateral expanse, to the outside (i.e., toward where the artificial magnetic conductor exists) of the space that is delineated by the width of the waveguide face 122a. In this example, the electromagnetic wave propagates in a direction (i.e., the Y direction) which is perpendicular to the plane of FIG. 7A. As such, the waveguide member 122 does not need to extend linearly along the Y direction, but may include a bend(s) and/or a branching portion(s) not shown. Since the electromagnetic wave propagates along the waveguide face 122a of the waveguide member 122, the direction of propagation would change at a bend, whereas the direction of propagation would ramify into plural directions at a branching portion.

In the waveguide structure of FIG. 7A, no metal wall (electric wall), which would be indispensable to a hollow waveguide, exists on both sides of the propagating electromagnetic wave. Therefore, in the waveguide structure of this example, “a constraint due to a metal wall (electric wall)” is not included in the boundary conditions for the electromagnetic field mode to be created by the propagating electromagnetic wave, and the width (size along the X direction) of the waveguide face 122a is less than a half of the wavelength of the electromagnetic wave.

For reference, FIG. 7B schematically shows a cross section of a hollow waveguide 330. With arrows, FIG. 7B schematically shows the orientation of an electric field of an electromagnetic field mode (TE₁₀) that is created in the internal space 332 of the hollow waveguide 330. The lengths of the arrows correspond to electric field intensities. The width of the internal space 332 of the hollow waveguide 330 needs to be set to be broader than a half of the wavelength. In other words, the width of the internal space 332 of the hollow waveguide 330 cannot be set to be smaller than a half of the wavelength of the propagating electromagnetic wave.

FIG. 7C is a cross-sectional view showing an implementation where two waveguide members 122 are provided on the conductive member 120. Thus, an artificial magnetic conductor that is created by the plurality of conductive rods 124 exists between the two adjacent waveguide members 122. More accurately, stretches of artificial magnetic conductor created by the plurality of conductive rods 124 are present on both sides of each waveguide member 122, such that each waveguide member 122 is able to independently propagate an electromagnetic wave.

For reference's sake, FIG. 7D schematically shows a cross section of a waveguide device in which two hollow waveguides 330 are placed side-by-side. The two hollow waveguides 330 are electrically insulated from each other. Each space in which an electromagnetic wave is to propagate needs to be surrounded by a metal wall that defines the respective hollow waveguide 330. Therefore, the interval between the internal spaces 332 in which electromagnetic waves are to propagate cannot be made smaller than a total of the thicknesses of two metal walls. Usually, a total of the thicknesses of two metal walls is longer than a half of the wavelength of a propagating electromagnetic wave. Therefore, it is difficult for the interval between the hollow waveguides 330 (i.e., interval between their centers) to be shorter than the wavelength of a propagating electromagnetic wave. Particularly for electromagnetic waves of wavelengths in the extremely high frequency range (i.e., electromagnetic wave wavelength: 10 mm or less) or even shorter wavelengths, a metal wall which is sufficiently thin relative to the wavelength is difficult to be formed. This presents a cost problem in commercially practical implementation.

On the other hand, a waveguide device 100 including an artificial magnetic conductor can easily realize a structure in which waveguide members 122 are placed close to one another. Thus, such a waveguide device 100 can be suitably used in an array antenna that includes plural antenna elements in a close arrangement.

Next, an exemplary construction for a slot antenna utilizing the aforementioned waveguide structure will be described. A “slot antenna” means an antenna device having one or plural slots (also referred to as “throughholes”) as antenna elements. In particular, a slot antenna having a plurality of slots as antenna elements will be referred to as a “slot array antenna” or a “slot antenna array”.

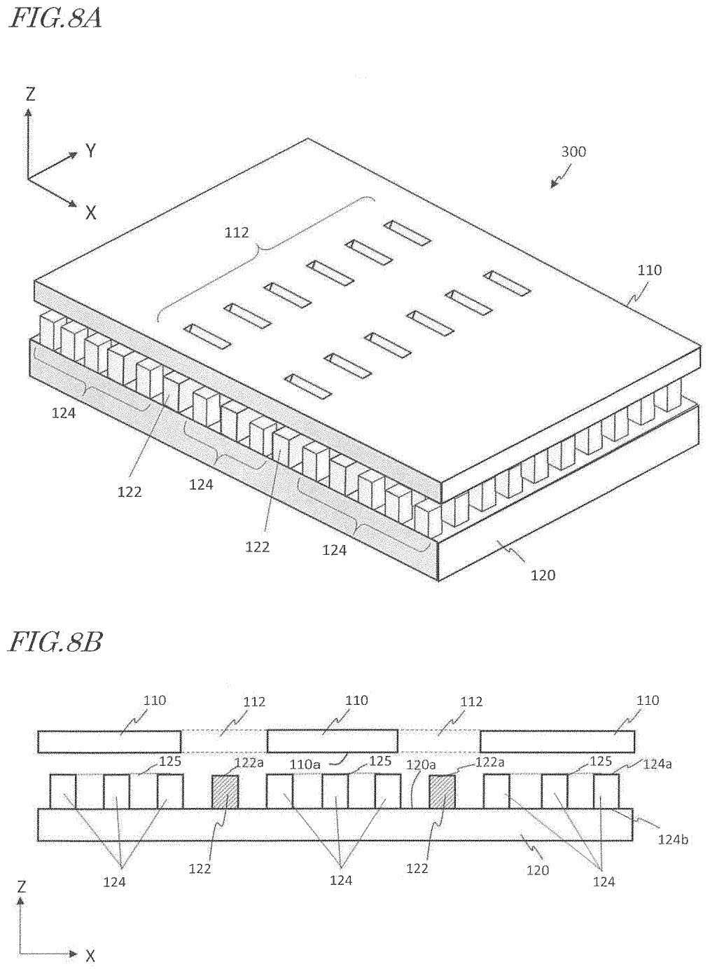

FIG. 8A is a perspective view schematically showing a portion of the construction of an antenna device 300 utilizing the aforementioned waveguide structure. FIG. 8B is a diagram showing schematically showing a portion of a cross section taken parallel to an XZ plane which passes through the centers of two adjacent slots 112 along the X direction of the antenna device 300. In the antenna device 300, the first conductive member 110 has a plurality of slots 112 arranged along the X direction and the Y direction. In this example, the plurality of slots 112 include two slot rows, each slot row including six slots 112 arranged at an equal interval along the Y direction. On the second conductive member 120, two waveguide members 122 extending along the Y direction are provided. Each waveguide member 122 has an electrically-conductive waveguide face 122a opposing one slot row. In a region between the two waveguide members 122 and in regions outside of the two waveguide members 122, a plurality of conductive rods 124 are disposed. These conductive rods 124 constitute an artificial magnetic conductor.

From an electronic circuit not shown, an electromagnetic wave is supplied to a waveguide extending between the waveguide face 122a of each waveguide member 122 and the conductive surface 110a of the conductive member 110. Among the plurality of slots 112 arranged along the Y direction, the distance between the centers of two adjacent slots 112 is designed so as to be equal in value to the wavelength of an electromagnetic wave propagating in the waveguide, for example. As a result of this, electromagnetic waves with an equal phase can be radiated from the six slots 112 arranged along the Y direction.

The antenna device 300 shown in FIG. 8A and FIG. 8B is an antenna array device in which the plurality of slots 112 serve as antenna elements (radiating elements). With such construction, the interval between the centers of radiating elements can be made shorter than a wavelength λo in free space of an electromagnetic wave propagating through the waveguide, for example. Horns may be provided for the plurality of slots 112. By providing horns, radiation characteristics or reception characteristics can be improved.

In each of the above examples, each rod 124 on the second conductive member 120 has a shape which is rotation symmetrical with respect to the axial center (see e.g. FIG. 2A or FIG. 2B). On the other hand, according to an example embodiment of the present disclosure, conductive rods (hereinafter simply referred to as “rods”) that are adjacent to a waveguide member (hereinafter referred to as “ridge”) on the second conductive member or to a throughhole in the second conductive member each have a shape which is not rotation symmetrical with respect to the axial center. More specifically, regarding the side faces of any given rod that is adjacent to a ridge or a throughhole, a side face that faces toward the side face of the ridge or toward the throughhole is substantially perpendicular to the surface of the second conductive member, while at least another side face has a shape that extends outward as going from the leading end toward the root. With such structure, deteriorations in the transmission loss of an electromagnetic wave propagating through a waveguide that is defined by the ridge or the throughhole can be suppressed, and a prompt design of a waveguide device having desired characteristics is facilitated.

Hereinafter, specific exemplary constructions of the present disclosure will be described. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the inventors so that those skilled in the art can sufficiently understand the present disclosure, are not intended to limit the scope of claims. In the present specification, identical or similar constituent elements are denoted by identical reference numerals.

### First Example Embodiment

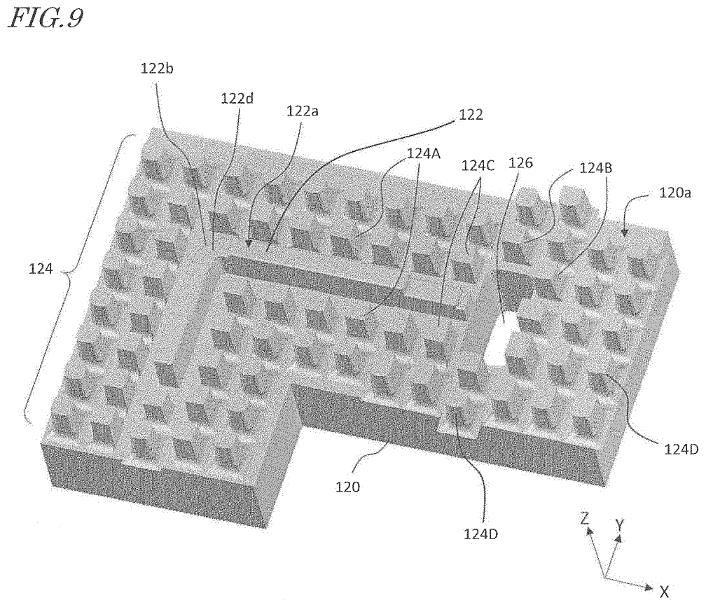

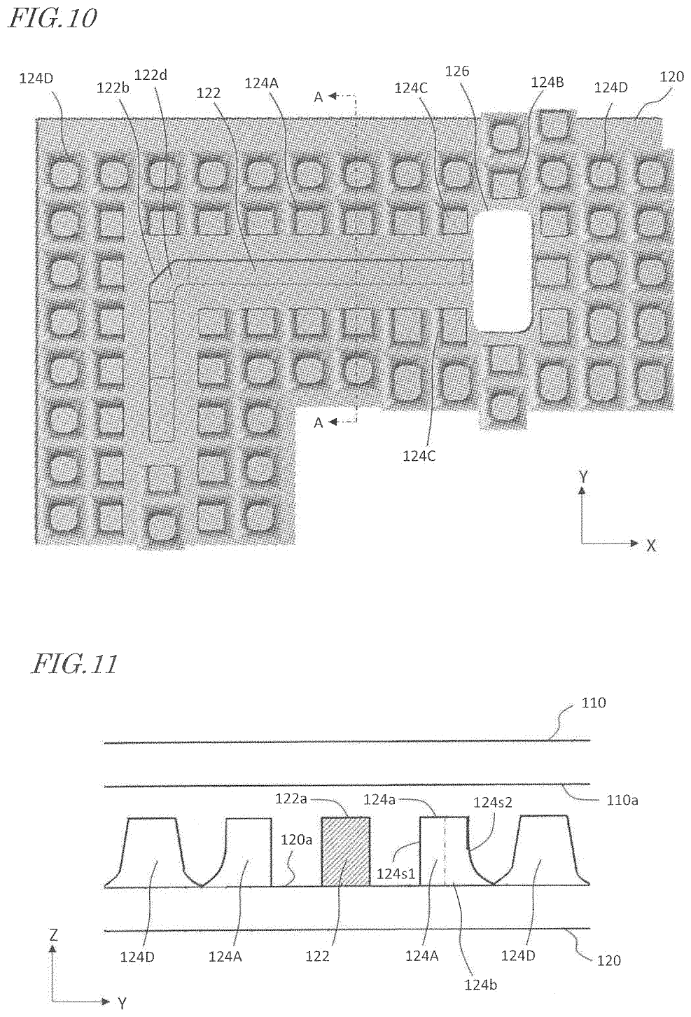

FIG. 9 is a perspective view showing a second conductive member 120 of a waveguide device according to an illustrative first example embodiment of the present disclosure, as well as the structure of a ridge 122 (electrically-conductive ridge) and a plurality of rods 124 (electrically-conductive rods) that are disposed thereon. FIG. 10 is a plan view of the structure shown in FIG. 9 as viewed from the +Z direction. In addition to the second conductive member 120, the ridge 122, and the plurality of rods 124 illustrated in the figures, the waveguide device of the present example embodiment also includes a first conductive member. The first conductive member may be an electrically-conductive plate similar to the conductive member 110 shown in FIG. 1 or FIG. 8A. The first conductive member has a conductive surface (first electrically conductive surface) opposing the conductive surface 120a (second electrically conductive surface) of the second conductive member 120, and covers the ridge 122 and the rods 124.

The waveguide device 100 can be used as a constituent element of an antenna device, for example. In combination with the first conductive member 110 having a plurality of slots 112 as shown in FIG. 8A, for example, a slot antenna array can be constructed. While FIG. 8A illustrates an example where two ridges 122 are provided, one ridge 122 is shown to be provided in the present example embodiment. The plurality of slots 112 in the first conductive member 110 may be disposed at positions opposing the waveguide face 122a of the ridge 122, or in a neighborhood thereof.

Each conductive member may be shaped by machining a metal plate, for example. Each conductive member may be shaped by a die-cast technique or the like. Each conductive member may be formed by making a plating layer on the surface of an electrically-insulative material such as a resin. As the electrically conductive material composing each conductive member, the ridge 122, and the rods 124, a metal such as magnesium may be used, for example.

The ridge 122 according to the present example embodiment has a bend 122b. The ridge 122 is structured so that a first portion extending along the Y direction and a second portion extending along the X direction are coupled via the bend 122b. Note that the illustrated structure of the ridge 122 is only an example; the ridge 122 may have various structures depending on the layout of the waveguide. The ridge 122 may have a branching portion beyond which it extends into two or more split directions. Without having a bend or a branching portion, the ridge 122 may simply extend in the manner of a straight line.

The ridge 122 according to the present example embodiment has a dent 122d at the position of the bend 122b. The dent 122d is provided for an improved impedance matching at the bend 122b. The first portion extending in the −Y direction from the bend 122b includes a stepped portion that has increasing heights toward the leading end. On the other hand, the second portion extending in the +X direction from the bend 122b includes a stepped portion that has decreasing heights toward the leading end. Such stepped portions also contribute to an improved impedance matching.

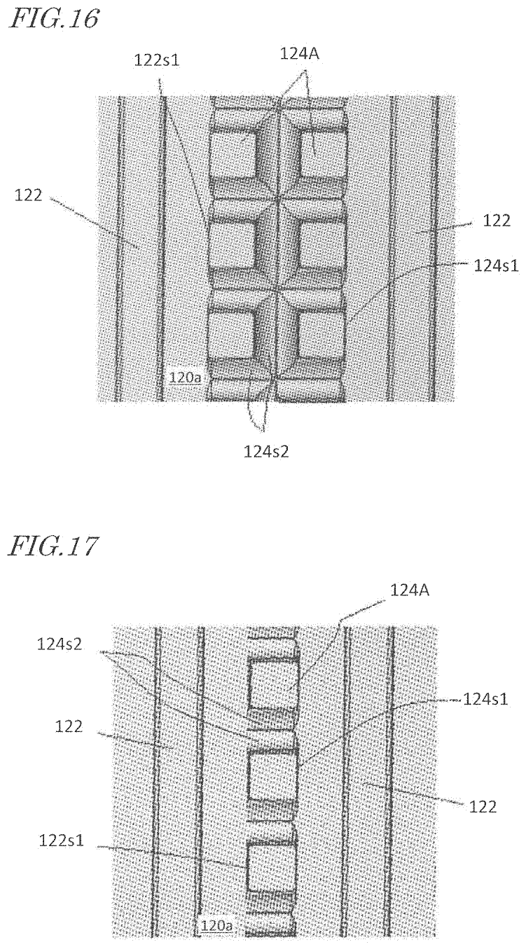

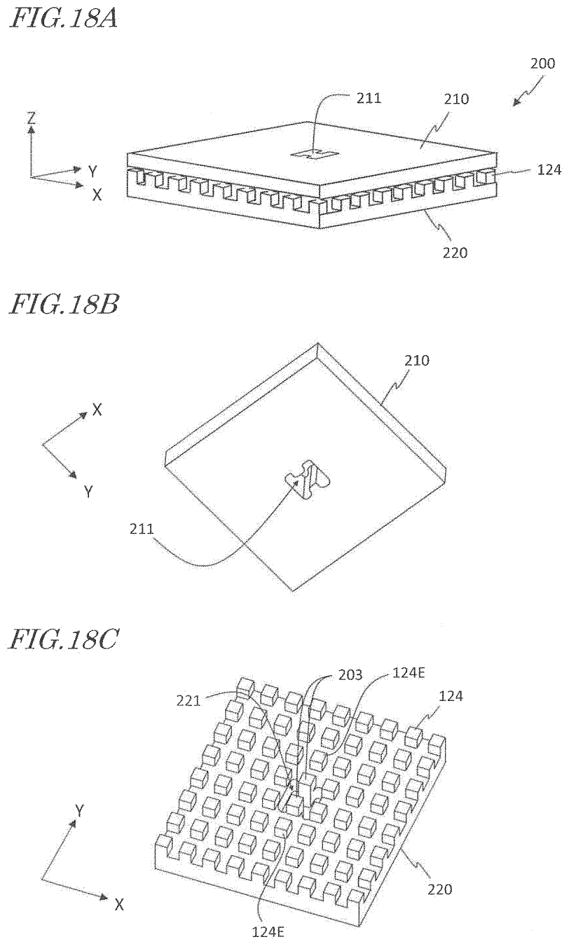

The second conductive member 120 has a throughhole 126. The throughhole 126 is at a position of the ridge 122 that is adjacent to the leading end of the second portion extending along the X direction. The throughhole 126 functions as a hollow waveguide which is connected to the waveguide extending between the ridge 122 and the first conductive member. The throughhole 126 may be connected to an electronic circuit such as a microwave integrated circuit, via another waveguide which is not shown. The electronic circuit may be disposed on the surface at the rear side (i.e., the −Z direction in FIG. 9) of the second conductive member 120, for example. The throughhole 126 may also be referred to as a “port”. The shape of the throughhole 126 as viewed from a direction which is perpendicular to the second conductive surface 120a is a near-rectangular shape extending along the Y direction. In the present specification, such a shape may be referred to an “I shape”. The shape of the throughhole 126 may differ from the shape that is shown. For example, as in the example embodiment illustrated in FIGS. 18A through 18C, an H-shaped throughhole may be provided.

The waveguide device of the present example embodiment has a two-layer structure including the first conductive member and the second conductive member 120. The waveguide device 100 may have a three-layer structure, or a structure with four or more layers. In that case, the waveguide device 100 will include the first conductive member, the second conductive member 120, and a third conductive member in this order. These three conductive members are to be layered with gaps between one another. Also between the second conductive member 120 and the third conductive member, a waveguide structure similar to the ridge waveguide shown in FIG. 9 may be formed.

In the example illustrated in FIG. 9 and FIG. 10, the plurality of rods 124 surround the ridge 122 and the throughhole 126. The plurality of rods 124 include: first rods 124A which only adjoin the ridge 122; second rods 124B which only adjoin the throughhole 126; third rods 124C which adjoin both the ridge 122 and the throughhole 126; and fourth rods 124D which adjoin neither the ridge 122 nor the throughhole 126. In FIG. 9 and FIG. 10, only some of the first rods 124A, the second rods 124B, the third rods 124C, and the fourth rods 124D are indicated with reference numerals. The first rods 124A may also be referred to as “ridge-side rods”; the second rods 124B as “throughhole-side rods”; and the third rods 124C as “ridge/throughhole-side rods”. In the present specification, the first rods 124A, the second rods 124B, the third rods 124C, and the fourth rods 124D may be indiscriminately referred to as “rods 124”.

The first rods 124A are disposed on both sides of the ridge 122, in a manner of following along the ridge 122. The number of first rods 124A is greater than the numbers of second rods 124B and third rods 124C. The second rods 124B, of which there are five in the present example embodiment, are disposed around the throughhole 126. The third rods 124C, of which there are two (thus being the smallest in number), are disposed in the neighborhood of the ridge 122 and the throughhole 126. The fourth rods 124D are disposed around the first rods 124A, the second rods 124B, and the third rods 124C. The number of fourth rods 124D is greater than the numbers of other rods 124A, 124B and 124C.

FIG. 11 is a cross-sectional view showing a portion of a cross-sectional structure taken at line A-A in FIG. 10. FIG. 11 illustrates two first rods 124A on both sides of the ridge 122 and two fourth rods 124D located on the outside therefrom. Each first rod 124A has a shape resembling a quadrangular prism, but is shaped so that a side face(s) 124s2 (hereinafter referred to as the “second side face”) thereof, other than a side face 124s1 (hereinafter referred to as the “first side face”) opposing the side face of the ridge 122, increasingly deviates outward from the axial center (which is indicated with a chain double-dashed line in FIG. 11) as going from the leading end 124a toward the root 124b. In the present example embodiment, the side face(s) 124s2 is a sloped surface(s) whose angle of inclination relative to the axial center increases as going from the leading end 124a toward the root 124b. On the other hand, the first side face 124s1 is flat and is substantially orthogonal to the second conductive surface 120a. The distance from the axial center to the first side face 124s1 at the root 124b is smaller than the distance from the axial center to the second side face(s) 124s2 at the root 124b. The widths of each first rod 124A (i.e., dimensions along the X direction and the Y direction) monotonically increase as going from the leading end 124a toward the root 124b. In the present example embodiment, the corners of the leading end 124a of each first rod 124A are slightly chamfered. Chamfering is optional, and may be omitted.

On the other hand, each fourth rod 124D is shaped so that all side faces thereof constitute sloped surfaces which increasingly deviate from the axial center as going from the leading end 124a toward the root 124b. Also, the width of each fourth rod 124D monotonically increases as going from the leading end 124a toward the root 124b. The corners of the leading end of each fourth rod 124D are chamfered to a greater extent than are those of each first rod 124A.

Usually, rods are easier to design when they are without a sloped surface. On the other hand, a study by the inventors shows that conferring a sloped surface to each rod facilitates impedance matching (see the specification of U.S. Pat. No. 10,027,032). In the present example embodiment, the side face 124s1 opposing the side face of the ridge 122 is not sloped, while the remaining side face(s) 124s2 is sloped. Such structure enables reconciliation between impedance matching and design ease. In the present example embodiment, furthermore, the dent 122d provided in the ridge 122 further improves impedance matching.

FIG. 12 is a diagram showing enlarged the structure surrounding the throughhole 126. As shown in FIG. 12, five second rods 124B and two third rods 124C are disposed around the throughhole 126.

Each second rod 124B has a shape resembling a quadrangular prism, similarly to the first rods 124A. However, each second rod 124B is shaped so that at least one side face thereof other than the side face that faces toward the throughhole 126 has a shape that increasingly deviates outward from the axial center as going from the leading end toward the root. In the present example embodiment, the aforementioned side face is a sloped surface whose angle of inclination relative to the axial center increases as going from the leading end toward the root. On the other hand, a side face that faces toward the throughhole 126 is flat and is substantially orthogonal to the second conductive surface 120a. At the root, the distance from the axial center to the side face that faces toward the throughhole 126 is smaller than the distance from the axial center to the side face that does not face toward the throughhole 126. The width of each second rod 124B monotonically increases as going from the leading end toward the root. In the present example embodiment, the corners of the leading end of each second rod 124B are slightly chamfered. Chamfering is optional, and may be omitted.

Each third rod 124C has a shape resembling a quadrangular prism, similarly to the first rods 124A and the second rods 124B. However, each third rod 124C is shaped so that a side face(s) thereof other than two side faces that respectively face toward the ridge 122 and the throughhole 126 has a shape that increasingly deviates outward from the axial center as going from the leading end toward the root. In the present example embodiment, the aforementioned side face(s) is a sloped surface(s) whose angle of inclination relative to the axial center increases as going from the leading end toward the root. On the other hand, the two side faces that respectively face toward the ridge 122 and the throughhole 126 are flat and are substantially orthogonal to the second conductive surface 120a. At the root, the distance from the axial center to the side face that faces toward the ridge 122 or the throughhole 126 is smaller than the distance from the axial center to any other side face. The width of each third rod 124C monotonically increases as going from the leading end toward the root. In the present example embodiment, the corners of the leading end of each third rod 124C are slightly chamfered. Chamfering is optional, and may be omitted.

Thus, regarding the side faces of each rod 124, the side face that faces toward the ridge 122 or the throughhole 126 is substantially perpendicular to the conductive surface 120a of the second conductive member 120, while at least another side face is structured so as to extend outward as going from the leading end toward the root. Such structure reduces energy losses of an electromagnetic wave propagating between the waveguide defined by the ridge 122 and the waveguide within the throughhole 126, and also allows for a prompt design.

The shapes of the respective rods 124 according to the present example embodiment are only examples. Hereinafter, variants of the shapes of the rods 124 will be described.

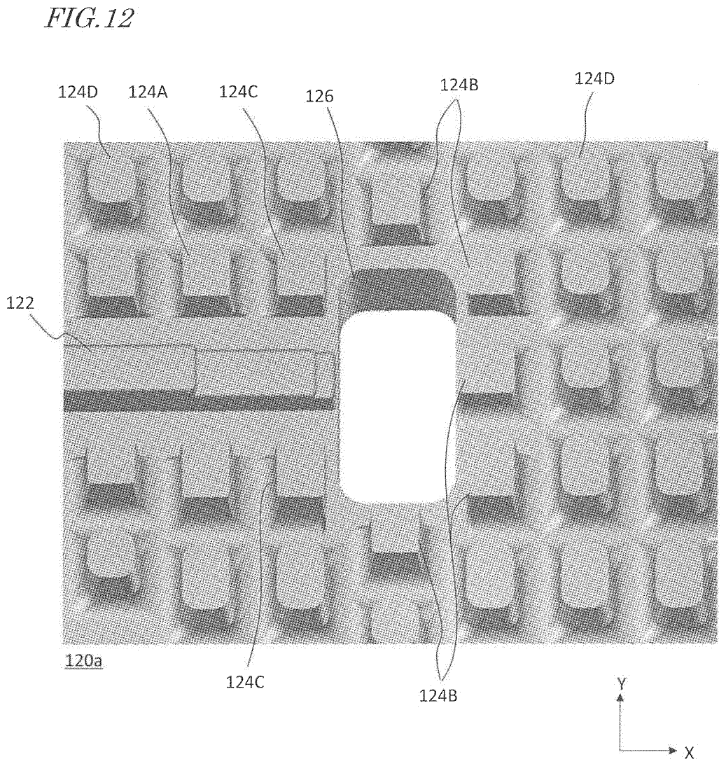

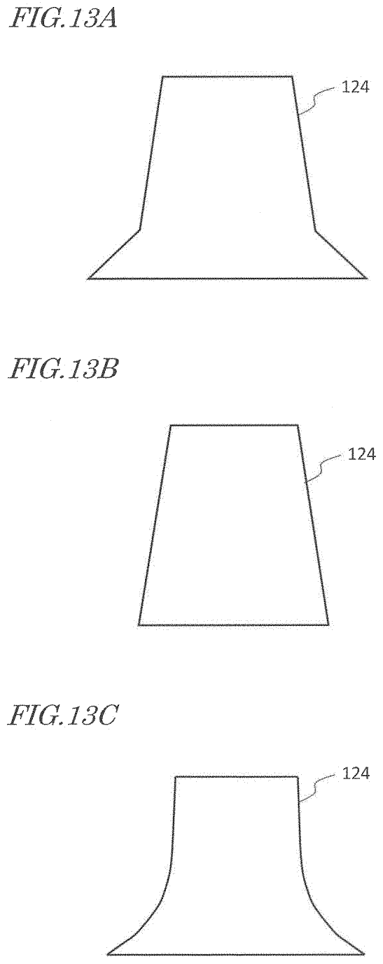

FIG. 13A is a cross-sectional view showing a first variant of the shape of a rod 124. The rod 124 of this example has two side faces whose angle of inclination changes in two steps from the leading end toward the root of the rod 124. The angle of inclination of these side faces may change in three or more steps. This shape is applicable to any of the first to fourth rods. When applied to the first to third rods, however, the side face that faces toward the ridge 122 or the throughhole 126 may be configured so as to be orthogonal to the conductive surface 120a of the second conductive member 120.

As in this example, at least one of the plurality of rods of the waveguide device may have a side face whose angle of inclination relative to the normal of the second conductive surface 120a of the second conductive member 120 changes in two or more steps. Rods having a side face(s) whose angle of inclination changes in two or more steps may adjoin the ridge 122 or the throughhole 126 on the second conductive member 120. In that case, the side face(s) whose angle of inclination changes in two or more steps does not face toward the ridge 122 or the throughhole 126. Regarding the changing angle of inclination of the side face(s) of a given rod relative to the normal of the second conductive surface 120a, the largest angle is greater than an angle of inclination of the side face, of that rod, that faces toward the ridge 122 or the throughhole 126 relative to the normal of the second conductive surface.

FIG. 13B is a diagram showing a second variant of the shape of a rod 124. The rod 124 of this example has at least two side faces whose angle of inclination relative to the normal of the second conductive surface 120a is constant, from the leading end toward the root. This shape is also applicable to any of the first to fourth rods. When applied to the first to third rods, however, the side face that faces toward the ridge 122 or the throughhole 126 may be configured so as to be orthogonal to the conductive surface 120a of the second conductive member 120.

FIG. 13C is a diagram showing a third variant of the shape of a rod 124. In the rod 124 of this example, from the leading end toward the root, the angle of inclination relative to the normal of the second conductive surface 120a continuously changes. Thus, a side face shape that gently expands from the leading end toward the root may be adopted. This shape is also applicable to any of the first to fourth rods. When applied to the first to third rods, however, the side face that faces toward the ridge 122 or the throughhole 126 may be configured so as to be orthogonal to the conductive surface 120a of the second conductive member 120.

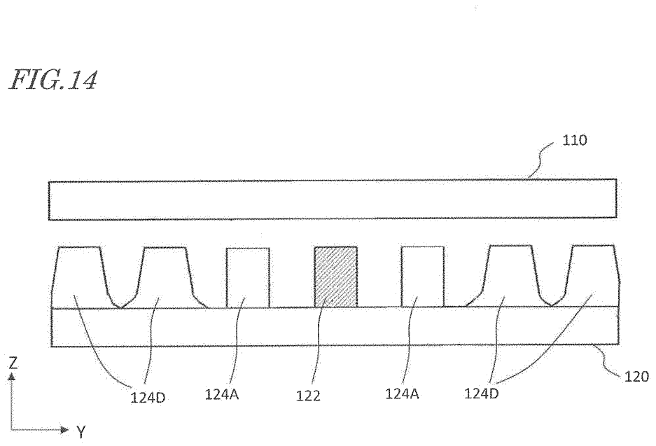

FIG. 14 is a cross-sectional view showing another variant of a rod shape. In this example, the first rods 124A adjoining the ridge 122 are quadrangular prisms without any sloped surface. Thus, at least one first rod 124A may lack a sloped surface.

FIG. 15 is a plan view showing another variant of first rods 124A. In this example, each first rod 124A has a semicircular-shaped leading end face. The side face 124s1 opposing the side face of the ridge 122 is substantially perpendicular to the second conductive surface 120a. The side face(s) 124s2 not opposing the side face of the ridge 122 is sloped so as to extend outward as going toward the root. All of the plurality of first rods 124A may have a semicircular-shaped leading end face as shown in FIG. 15, or only some of the first rods 124A may have such a semicircular-shaped leading end face. For example, first rods 124A having a quadrangular prism shape and first rods 124A having a semicircular-shaped leading end face may be alternately disposed along the ridge 122. The rod structure shown in FIG. 15 is also applicable to the second rods 124B and the third rods 124C. In that case, the side face that faces toward the ridge 122 or the throughhole 126 may be configured so as to be substantially perpendicular to the second conductive surface 120a.

### Second Example Embodiment

FIG. 16 is a plan view showing the construction of a portion of a waveguide device according to a second example embodiment. In the second example embodiment, two or more ridges 122 are disposed apart from each other and in parallel, on the second conductive member 120. The shape of each ridge 122 in the present example embodiment is a linear shape. Between the two ridges 122, two rod rows, each including a plurality of first rods 124A, are arranged. Each of the first rods 124A adjoining the ridge 122 has a shape resembling a quadrangular prism, such that the corners of its leading end are slightly chamfered. Among the four side faces of each first rod 124A in this example, the side face 124s1 that faces toward the side face of the ridge 122 is substantially perpendicular to the second conductive surface 120a. The remaining side face(s) 124s2 is a sloped surface(s) that extends outward toward the root.

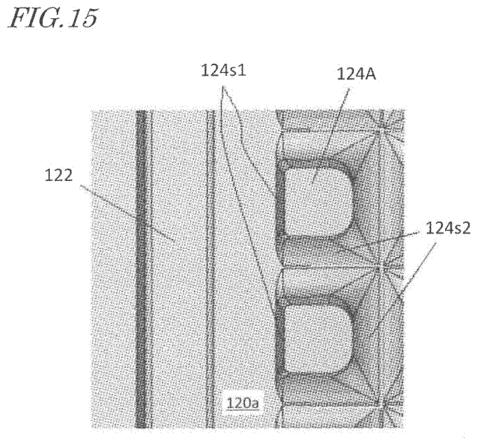

FIG. 17 is a plan view showing the construction of a portion of a waveguide device according to a variant of the second example embodiment. In this example, too, two or more ridges 122 are disposed apart from each other and in parallel. Between the two ridges 122, one rod row including a plurality of first rods 124A is arranged. In this example, among the four side faces of each first rod 124A, two side faces 122s1 that face toward the side face of the ridge 122 are substantially perpendicular to the second conductive surface 120a. The remaining side faces 124s2 are a sloped surfaces that extends outward toward the root.

### Third Example Embodiment

FIG. 18A is a perspective view schematically showing a portion of a waveguide device 200 according to a third example embodiment. The waveguide device 200 includes a first conductive member 210 and a second conductive member 220. The first conductive member 210 and the second conductive member 220 are fixed to each other at a peripheral portion not shown, so as to be opposed to each other via a gap. The first conductive member 210 and the second conductive member 220 extend along the XY plane.

FIG. 18B is a perspective view showing the structure of the first conductive member 210 in FIG. 18A on the side that is opposed to the second conductive member 220. The first conductive member 210 has a first throughhole 211. The inner walls of the first conductive member 210 and the throughhole 211 both have an electrically-conductive surface.

FIG. 18C is a perspective view showing the structure of the second conductive member 220 in FIG. 18A on the side that is opposed to the first conductive member 210. The second conductive member 220 includes: a second throughhole 221; a pair of waveguiding walls 203 (bumps) that are disposed so as to sandwich the central portion of the second throughhole 221; and a plurality of electrically-conductive rods 124 surrounding the pair of waveguiding walls 203. The pair of waveguiding walls 203 are arranged along the Y direction. The rods 124 are arranged in rows and columns along the X direction and along the Y direction. Note that the rods 124 may not be arranged in rows or columns, but dispersed without showing any simple regularity. The inner wall of the throughhole 221, the pair of waveguiding walls 203, and the plurality of rods 124 each have an electrically-conductive surface.

The waveguide device 200 may be used as a portion of an antenna device that includes a plurality of layered conductive members. Via the throughholes 211 and 221, two waveguides that are in other layers not shown can be connected. For example, an electromagnetic wave which has propagated along the vertical direction via the throughholes 211 and 221 may be further propagated by a WRG structure in another layer (e.g., a structure as shown in FIG. 9).

The opening of each of the first throughhole 211 and the second throughhole 221 according to the present example embodiment includes a lateral portion extending along the X direction and a pair of vertical portions extending along the Y direction from both ends of the lateral portion. Both ends of the lateral portion are connected to central portions of the pair of vertical portions. Such a shape, resembling the alphabetical letter “H”, may be referred to as an “H shape”.

The inner wall surface of each throughhole 211, 221 has two protrusions that protrude inwardly. The portion between the two protrusions correspond to the lateral portion. Although this example illustrates that the vertical portions extend perpendicularly to the lateral portion, they do not need to extend perpendicularly.

The throughhole 221 having an H shape may be designed so that twice the length from the center point of the lateral portion to either end of the vertical portion as taken along the lateral portion and the vertical portion is equal to or greater than a half of the free space wavelength λo corresponding to the center frequency of the frequency band used. This allows an electromagnetic wave to be propagated along the side faces of the pair of protrusions and the pair of waveguiding walls 203.

Each throughhole 211, 221 may have a shape other than an H shape. For example, it may have an I shape that only includes a lateral portion extending along the X direction. The shape, size, and arrangement of the first throughhole 211 and the second throughhole 221 may be freely selected so long as electromagnetic waves can be propagated between them.

The second conductive member 220 according to the present example embodiment can be produced by forming a plating layer on the surface of an intermediate member that is made of resin, the intermediate member having a throughhole and a plurality of rods, for example.

The plurality of rods 124 include two waveguiding wall-side rods 124E (hereinafter referred to as “fifth rods 124E”) that are located outside (along the Y direction) of the pair of waveguiding walls 203. Each fifth rod 124E has a shape similar to that of each first rod 124A or second rod 124B described above.

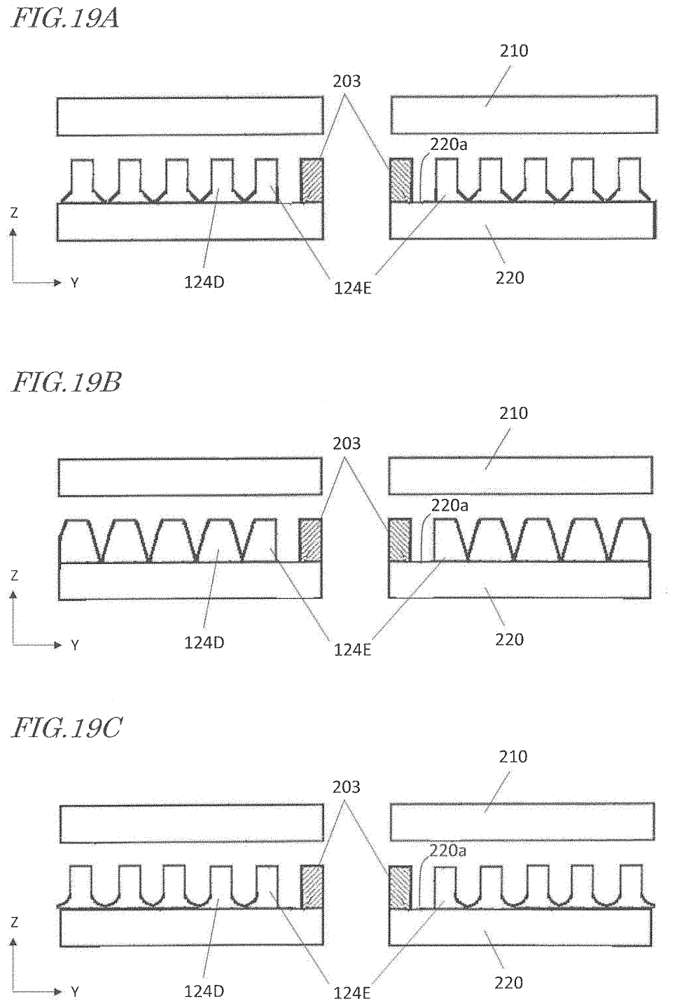

FIG. 19A is a diagram showing a YZ-plane cross section of the waveguide device 200 shown in FIG. 18A that passes through the pair of waveguiding walls 203. Regarding the side faces of each fifth rod 124E, a side face that is opposed to the side face of any waveguiding wall 203 is flat and is substantially orthogonal to the conductive surface 220a of the second conductive member 220. The remaining side face(s) of each fifth rod 124E has a shape that increasingly deviates outward from the axial center as going from the leading end toward the root. Regarding the rods 124D other than the fifth rods 124E, any side face thereof has a shape that increasingly deviates outward from the axial center as going from the leading end toward the root. In the example of FIG. 19A, a sloped surface is provided only near the root of each rod, and the neighborhood of the leading end of each side face is substantially perpendicular to the second conductive surface 220a.

FIG. 19B is a cross-sectional view showing a variant of the present example embodiment. In this example, regarding the side faces of each fifth rod 124E, a side face(s) other than a side face that is opposed to the side face of any waveguiding wall 203 is sloped with a constant angle of inclination relative to the axial center of the rod. Each side face of the other rods 124D also has a similar sloped surface.

FIG. 19C is a cross-sectional view showing another variant of the present example embodiment. In this example, regarding the side faces of each fifth rod 124E, a side face(s) other than a side face that is opposed to the side face of any waveguiding wall 203 gently increasingly deviates from the axial center as going from the leading end toward the root. Each side face of the other rods 124D also has a similar sloped surface.

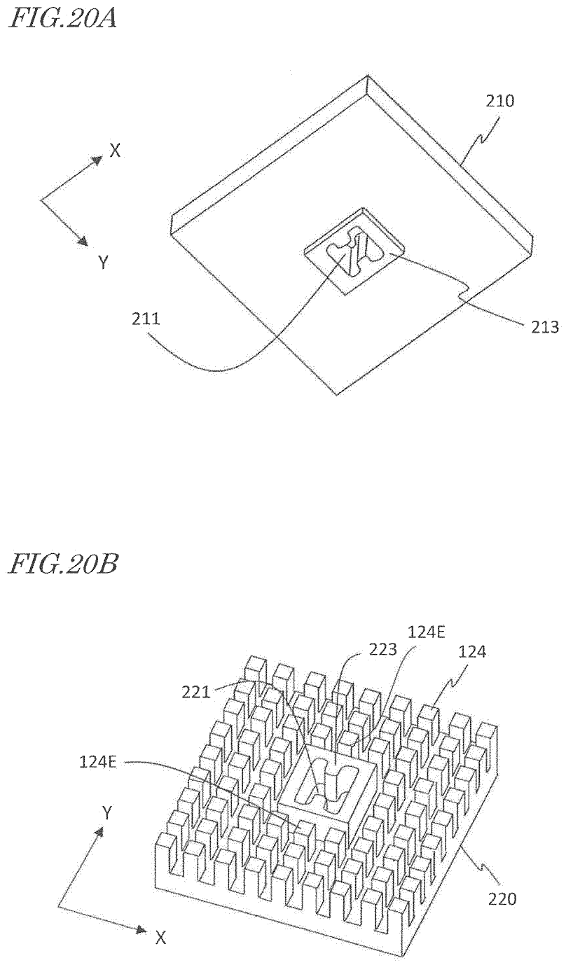

Next, with reference to FIG. 20A and FIG. 20B, a variant of the waveguiding walls 203 will be described.

FIG. 20A is a perspective view showing a first conductive member 210 according to this variant. FIG. 20B is a perspective view showing a second conductive member 220 according to this variant. In this variant, the first conductive member 210 includes a first waveguiding wall 213, and the second conductive member 220 includes a second waveguiding wall 223. The first waveguiding wall 213 surrounds the first throughhole 211. The second waveguiding wall 223 surrounds the second throughhole 221. Otherwise, its construction is similar to the aforementioned construction. In this example, too, a plurality of rods 124 are provided outside of the throughhole 221 and the waveguiding wall 223. The plurality of rods 124 include a plurality of fifth rods 124E adjoining the waveguiding wall 223.

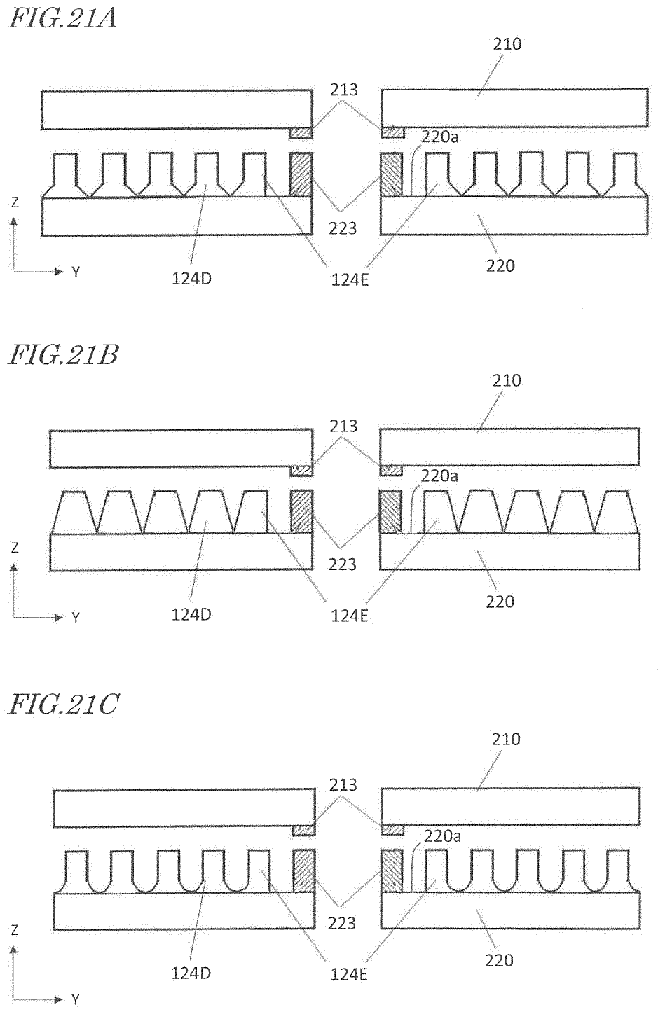

FIG. 21A is a diagram showing a YZ-plane cross section that passes through a pair of protrusions that are at the center of the waveguiding wall 223 shown in FIG. 20B. Regarding the side faces of each fifth rod 124E, a side face that is opposed to the side face of any second waveguiding wall 223 is flat and is substantially orthogonal to the conductive surface 220a of the second conductive member 220. The remaining side face(s) of the fifth rods 124E has a shape that increasingly deviates outward from the axial center as going from the leading end toward the root. Regarding the rods 124D other than the fifth rods 124E, any side face thereof has a shape that increasingly deviates outward from the axial center as going from the leading end toward the root. In the example of FIG. 21A, a sloped surface is provided only near the root of each rod, and the neighborhood of the leading end of each side face is substantially perpendicular to the second conductive surface 220a.

FIG. 21B is a cross-sectional view showing a variant of the present example embodiment. In this example, regarding the side faces of each fifth rod 124E, a side face(s) other than a side face that is opposed to the side face of any second waveguiding wall 223 is sloped with a constant angle of inclination relative to the axial center of the rod. Each side face of the other rods 124D also has a similar sloped surface.

FIG. 21C is a cross-sectional view showing another variant of the present example embodiment. In this example, regarding the side faces of each fifth rod 124E, a side face(s) other than a side face that is opposed to the side face of any second waveguiding wall 223 gently increasingly deviates from the axial center as going from the leading end toward the root. Each side face of the other rods 124D also has a similar sloped surface.

### Fourth Example Embodiment

Next, an example embodiment of an antenna device that includes a waveguide device and at least one antenna element (radiating element) which is connected to a waveguide in the waveguide device will be described. To be “connected to a waveguide” means either being directly connected, or being indirectly connected via another waveguide, to the waveguide. The antenna device according to the present example embodiment is used for at least one of transmission and reception of signals.

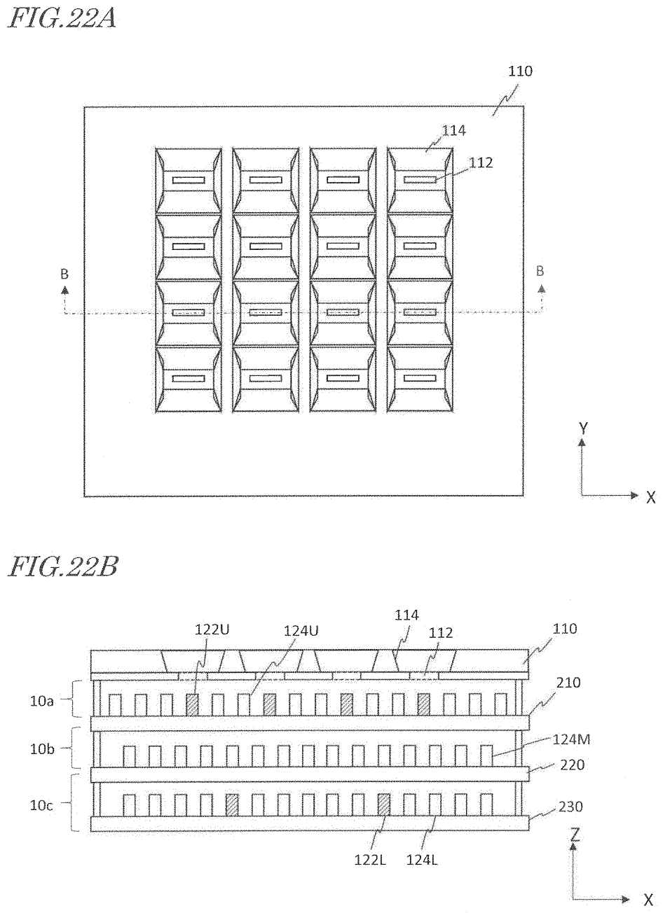

FIG. 22A is a diagram showing an example of an antenna device (antenna array) in which a plurality of slots (apertures) are arrayed. FIG. 22A is an upper plan view showing the antenna device as viewed from the +Z direction. FIG. 22B is a cross-sectional view taken along line B-B in FIG. 22A. In the antenna device shown, the following are layered: a first waveguiding layer 10a including a plurality of ridges 122U that directly couple to a plurality of slots 112 functioning as radiating elements; a second waveguiding layer 10b including a plurality of rods 124M and waveguiding walls not shown; and a third waveguiding layer 10c including another ridge 122L that couples to the ridges 122U of the first waveguiding layer 10a via the waveguiding walls. The plurality of ridges 122U and a plurality of rods 124U in the first waveguiding layer 10a are disposed on the first conductive member 210. The plurality of rods 124M and the waveguiding walls not shown in the second waveguiding layer 10b are disposed on the second conductive member 220. The ridge 122L and the plurality of rods 124L in the third waveguiding layer 10c are disposed on the third conductive member 230.

This antenna device further includes a conductive member 110 that covers the ridges 122U and the rods 124U in the first waveguiding layer 10a. The conductive member 110 has 16 slots (apertures) 112 that are arrayed in four rows and four columns. On the conductive member 110, side walls 114 surrounding each slot 112 are provided. For each slot 112, the side walls 114 constitute a horn for adjusting the directivity of the slot 112. The number and arrangement of slots 112 in this example are only an example. The orientation and shape of each slot 112 are not limited to the example shown. For example, H-shaped slots may be used. Likewise, what is shown in the figures should not be seen as a limitation as to whether the side walls 114 of the horn are sloped or not, angles thereof, or the horn shape.

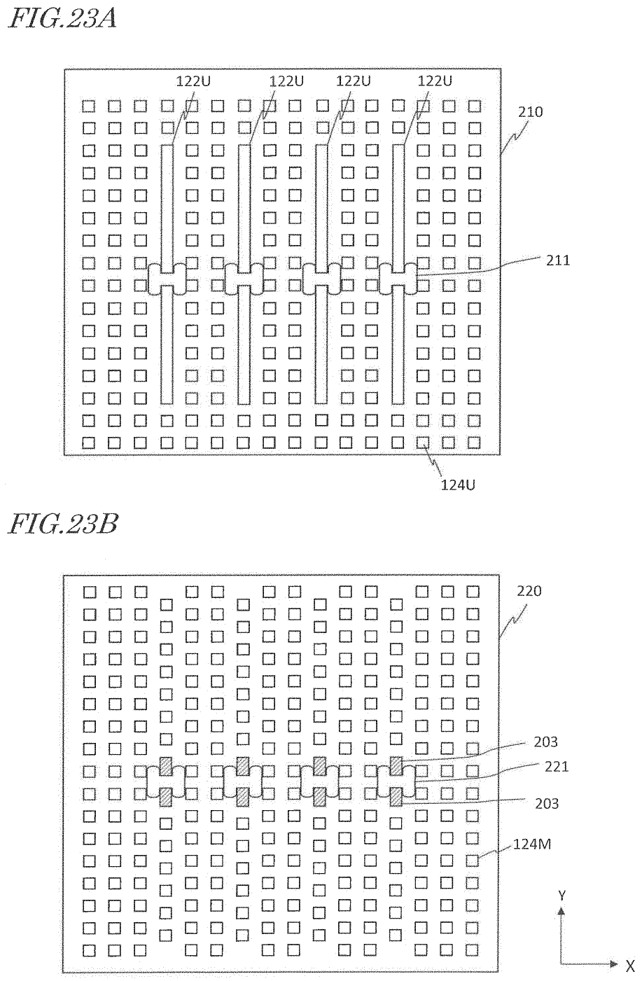

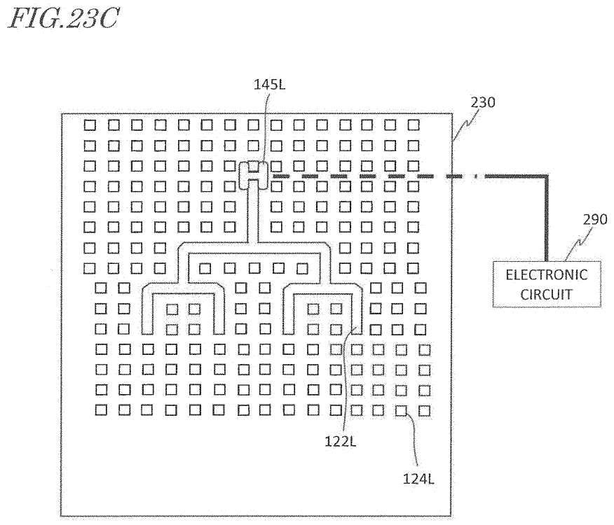

FIG. 23A is a diagram showing a planar layout of the ridges 122U and the rods 124U on the first conductive member 210. FIG. 23B is a diagram showing a planar layout of the rods 124M, the waveguiding walls 203, and the throughhole 221 on the second conductive member 220. FIG. 23C is a diagram showing a planar layout of the ridge 122L and the rods 124L on the third conductive member 230. As shown in these figures, the ridges 122U on the first conductive member 210 extend in linear shapes (stripes), without having any branching portions or bends. On the other hand, the ridge 122L on the third conductive member 230 includes both of: branching portions beyond each of which it extends into two split directions; and bends beyond each of which it extends in a different direction. Between each throughhole 211 in the first conductive member 210 and each throughhole 221 in the second conductive member 220, as shown in FIG. 23B, the pair of waveguiding walls 203 are disposed. Although the present example embodiment illustrates waveguiding walls 203 of the type shown in FIG. 18C, waveguiding walls 213, 223 of the types shown in FIG. 20A and FIG. 20B may be provided instead.

Although not shown in FIG. 23A, among the plurality of rods 124U, the side faces of those rods which adjoin the ridges 122U or the throughholes 211 have a similar structure to that of the side faces of those rods which adjoin the ridge 122 or the throughhole 126 in Example embodiment 1. Specifically, the side face of those rods which adjoin any ridge 122U that is opposed to the side face of the ridge 122U is substantially perpendicular to the surface of the conductive member 210, while its remaining side face(s) has a shape that gradually extends outward as going from the leading end toward the root. Moreover, the side face of those rod which adjoin any throughhole 211 that faces toward the throughhole 211 is substantially perpendicular the surface of the conductive member 210, while its remaining side face(s) has a shape that gradually extends outward as going from the leading end toward the root.

In the example shown in FIG. 23B, four throughholes 221 exist in the second conductive member 220. Four pairs of waveguiding walls 203 are disposed so as to each sandwich the central portion of the respective throughhole 221. The ridges 122U on the first conductive member 210 couple to the ridge 122L on the third conductive member 230 via the throughholes 211, the pair of waveguiding walls 203, and the throughholes 221. In other words, an electromagnetic wave which has propagated along the ridge 122L on the third conductive member 230 passes through the throughholes 221, the pair of waveguiding walls 203, and the throughholes 211 to reach the ridges 122U on the first conductive member 210, and propagates along the ridges 122U. In this case, each slot 112 functions as an antenna element to allow an electromagnetic wave which has propagated through the waveguide to be radiated into space. Conversely, when an electromagnetic wave which has propagated in space impinges on a slot 112, the electromagnetic wave couples to the ridge 122U that lies immediately under that slot 112, and propagates along the ridge 122U. An electromagnetic wave which has propagated along a ridge 122U may also pass through the throughhole 211, the pair of waveguiding walls 203, and the throughhole 221 to reach the ridge 122L on the third conductive member 230, and propagate along the ridge 122L.

Via a port (throughhole) 145L in the third conductive member 230, the ridge 122L may couple to an external waveguide device or electronic circuit (e.g., radio frequency circuit). As one example, FIG. 23C illustrates an electronic circuit 290 which is connected to the port 145L. Without being limited to a specific position, the electronic circuit 290 may be provided at any arbitrary position. The electronic circuit 290 may be provided on a circuit board which is on the rear surface side (i.e., the lower side in FIG. 22B) of the third conductive member 230, for example. Such an electronic circuit may include a microwave integrated circuit, e.g. an MMIC (Monolithic Microwave Integrated Circuit) that generates or receives millimeter waves, for example. In addition to the microwave integrated circuit, the electronic circuit 290 may further include another circuit, e.g., a signal processing circuit. Such a signal processing circuit may be configured to execute various processes that are necessary for the operation of a radar system that includes an antenna device, for example. The electronic circuit 290 may include a communication circuit. The communication circuit may be configured to execute various processes that are necessary for the operation of a communication system that includes an antenna device.

Note that a structure for connecting an electronic circuit to a waveguide is disclosed in, for example, US Patent Publication No. 2018/0351261, US Patent Publication No. 2019/0006743, US Patent Publication No. 2019/0139914, US Patent Publication No. 2019/0067780, US Patent Publication No. 2019/0140344, and International Patent Application Publication No. 2018/105513. The entire disclosure of these publications is incorporated herein by reference.

Although not shown in FIG. 23B, among the plurality of rods 124M, the side faces of those rods which adjoin the throughholes 221 or the waveguiding walls 203 have a similar structure to that of the side faces of those rods which adjoin the throughholes 221 or the waveguiding walls 203 in Example embodiment 3.

The conductive member 110 shown in FIG. 23A may be called a “radiation layer”. The layer containing the entirety of the ridges 122U and the rods 124U on the first conductive member 210 shown in FIG. 23A may be called an “excitation layer”; the layer containing the entirety of the rods 124M and the waveguiding walls 203 on the second conductive member 220 shown in FIG. 23B may be called an “intermediate layer”; and the layer containing the entirety of the ridge 122L and the rods 124L on the third conductive member 230 shown in FIG. 23C may be called a “distribution layer”. Moreover, the “excitation layer”, the “intermediate layer”, and the “distribution layer” may be collectively called a “feeding layer”. Each of the “radiation layer”, the “excitation layer”, the “intermediate layer”, and the “distribution layer” can be mass-produced by processing a single metal plate. The radiation layer, the excitation layer, the distribution layer, and any electronic circuitry to be provided on the rear face side of the distribution layer may be produced as a single-module product.

In the antenna array of this example, as can be seen from FIG. 22B, a plurality of plate-like conductive members are layered, so that, as a whole, a flat panel antenna which is flat and low-profiled is realized. For example, the height (thickness) of a multilayer structure having a cross-sectional construction as shown in FIG. 22B can be made 20 mm or less.

With the ridge 122L shown in FIG. 23C, the distances from the port 145L of the third conductive member 230 to the respective throughholes 211 (see FIG. 23A) in the first conductive member 210 as measured along the ridge 122L are all equal. Therefore, a signal wave which is input from the port 145L of the third conductive member 230 to the ridge 122L reaches the four throughholes 211 in the first conductive member 210 all in the same phase. As a result, the four ridges 122U on the first conductive member 210 can be excited in the same phase.

Note that it is not necessary for all slots 112 functioning as antenna elements to radiate electromagnetic waves in the same phase. The network patterns of the ridges 122 in the excitation layer and the distribution layer may be arbitrary, and each ridge 122 may be configured to independently propagate a mutually different signal.

Although the ridges 122U on the first conductive member 210 according to the present example embodiment lacks branching portions and bends, portions thereof that function as the excitation layer may include at least one of a branching portion(s) and a bend(s). As described earlier, it is not necessary for all rods in the waveguide device to have similar shapes.

According to the present example embodiment, between the throughholes 211 in the first conductive member 210 and the throughholes 221 in the second conductive member 220, electromagnetic waves can be directly propagated via the pairs of electrically-conductive waveguiding walls 203. Since unwanted propagation does not occur on the second conductive member 220, structures such as other waveguides, circuit boards, or a camera may be disposed on the second conductive member 220. Thus, the device enjoys an improved design freedom. Although the present example embodiment illustrates that the waveguiding walls are disposed between the first conductive member 210 and the second conductive member 220, the waveguiding walls may be disposed in other positions.

When constructing an excitation layer and a distribution layer, various circuit elements in waveguides can be utilized. Examples thereof are disclosed in U.S. Pat. Nos. 10,042,045, 10,090,600, 10,158,158, International Patent Application Publication No. 2018/207796, International Patent Application Publication No. 2018/207838, and US Patent Publication No. 2019/0074569, for example. The entire disclosure of these publications is incorporated herein by reference.

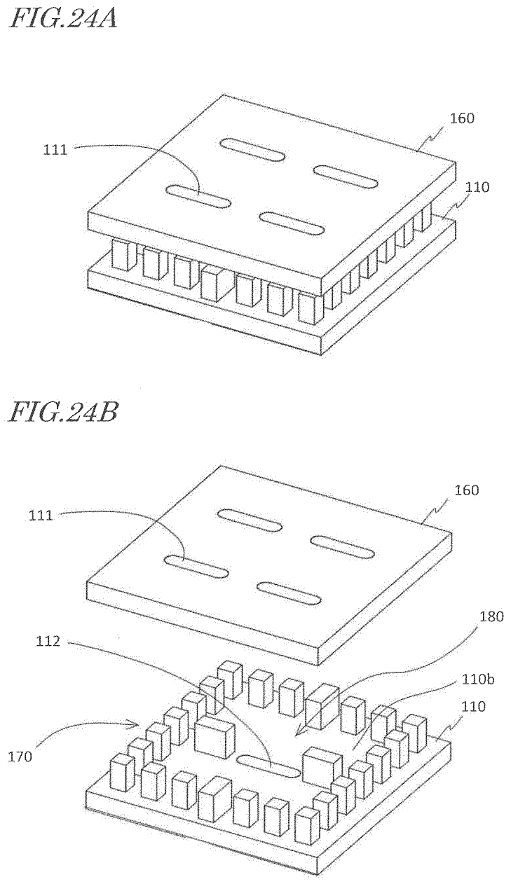

FIG. 24A is a perspective view showing one radiating element of a slot antenna device according to still another variant. The radiating element shown in FIG. 24A is illustrated while exaggerating the spacing between a conductive member 110 and a further conductive member 160. The slot antenna device of this example additionally includes the further conductive member 160, which has a conductive surface that is opposed to the conductive surface 110b on the front side of the conductive member 110. In this example, the further conductive member 160 has four further slots 111. FIG. 24B is illustrated so that the spacing between the conductive members 110 and 160 is exaggerated for ease of understanding.

While each slot 112 in FIG. 22A communicates with a horn, the slot 112 in the example shown in FIGS. 24A and 24B communicates with a cavity 180. The cavity 180 is a flat hollow that is surrounded by the conductive surface 110b, the plurality of rods 170 provided on the front side of the conductive member 110, and a conductive surface on the rear side of the further conductive member 160. In the example shown in FIGS. 24A and 24B, a gap exists between the leading ends of the plurality of rods 170 and the conductive surface on the rear side of the further conductive member 160. The roots of the plurality of rods 170 are connected to the conductive surface 110b of the conductive member 110. A construction may also be adopted where the plurality of rods 170 are connected to the further conductive member 160. In that case, however, a gap is needed between the leading ends of the plurality of rods 170 and the conductive surface 110b.

The conductive member 160 has four slots 111, each slot 111 communicating with the cavity 180. A signal wave which is radiated from the slot 112 into the cavity 180 is radiated toward the front side of the conductive member 160 via the four slots 111. A structure may also be adopted where a horn is provided on the front side of the conductive member 160, such that the slots 111 open at the bottom of that horn. In this case, a signal wave which is radiated from the slot 112 is radiated via the cavity 180, the slots 111, and the horn.

Next, variants of the shape of each throughhole (slot or port) according to example embodiments of the present disclosure will be described. A cross section that is taken perpendicular to the axis of the throughhole may have shapes as described in the following, for example. The variants presented below are similarly applicable to any example embodiment of the present disclosure.

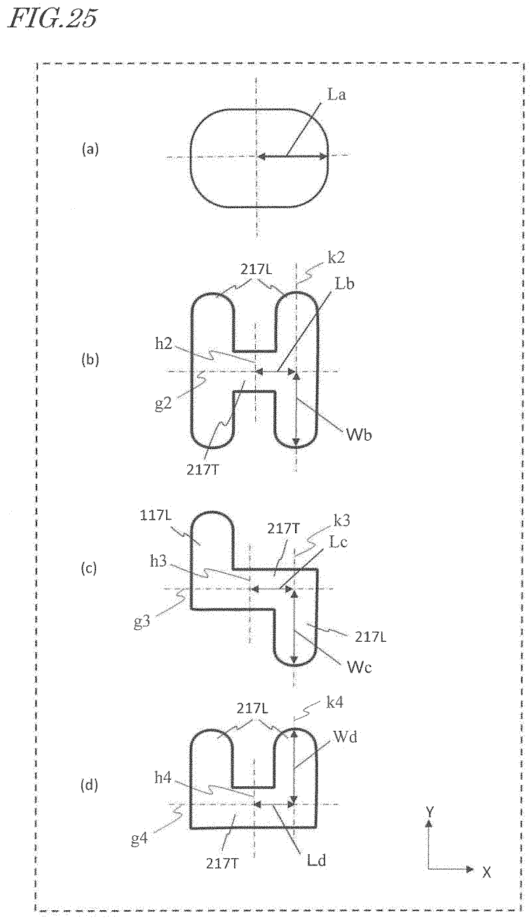

In FIG. 25, (a) shows an exemplary hollow waveguide having the shape of an ellipse. The semimajor axis La of the hollow waveguide indicated by arrowheads in the figure is chosen so that higher-order resonance will not occur and that the impedance will not be too small. More specifically, La may be chosen so that λo/4<La<λo/2, where λo is a wavelength in free space corresponding to the center frequency in the operating frequency band.

In FIG. 25, (b) shows an exemplary hollow waveguide having an H shape that includes a pair of vertical portions 217L and a lateral portion 217T interconnecting the pair of vertical portions 217L. The lateral portion 217T is substantially perpendicular the pair of vertical portions 217L, and connects between the substantial central portions of the pair of vertical portions 217L. Such an H-shape hollow waveguide will also have its shape and size determined so that higher-order resonance will not occur and that the impedance will not be too small. Let the distance from a point of intersection between a center line g2 of the lateral portion 217T and a center line h2 of the overall H shape taken perpendicular to the lateral portion 217T to a point of intersection between the center line g2 and a center line k2 of a vertical portion 217L be Lb. Let the distance from a point of intersection between the center line g2 and the center line k2 to an end of the vertical portion 217L be Wb. Then, a sum of Lb and Wb is chosen so as to satisfy λo/4<Lb+Wb<λo/2. Choosing the distance Wb to be relatively long allows the distance Lb to be relatively short. As a result, the width along the X direction of the H shape can be e.g. less than λo/2, whereby the interval between the lateral portions 217T along the longitudinal direction can be made short.

In FIG. 25, (c) shows an exemplary hollow waveguide that includes a lateral portion 217T and a pair of vertical portions 217L extending from both ends of the lateral portion 217T. The directions in which the pair of vertical portions 217L extend from the lateral portion 217T are substantially perpendicular to the lateral portion 217T, and are opposite to each other. Let the distance from a point of intersection between a center line g3 of the lateral portion 217T and a center line h3 of the overall shape taken perpendicular to the lateral portion 217T and a point of intersection between the center line g3 and a center line k3 of a vertical portion 217L be Lc. Let the distance between a point of intersection between the center line g3 and the center line k3 and the end of the vertical portion 217L be Wc. Then, a sum of Lc and Wc is chosen so as to satisfy λo/4<Lc+Wc<λo/2. Choosing the distance Wc to be relatively long allows the distance Lc to be relatively short. As a result, the width along the X direction of the overall shape of (c) in FIG. 25 can be e.g. less than λo/2, whereby the interval between the lateral portions 217T along the longitudinal direction can be made short.

In FIG. 25, (d) shows an exemplary hollow waveguide that includes a lateral portion 217T and a pair of vertical portions 217L extending from both ends of the lateral portion 217T in an identical direction which is perpendicular to the lateral portion 217T. Such a shape may be referred to as a “U shape” in the present specification. Note that the shape of (d) in FIG. 25 may be regarded as an upper half shape of an H shape. Let the distance from a point of intersection between a center line g4 of the lateral portion 217T and a center line h4 of the overall U shape taken perpendicular to the lateral portion 217T to a point of intersection between the center line g4 and a center line k4 of a vertical portion 217L be Ld. Let the distance from a point of intersection between the center line g4 and the center line k4 and the end of the vertical portion 217L be Wd. Then, a sum of Ld and Wd is chosen so as to satisfy λo/4<Ld+Wd<λo/2. Choosing the distance Wd to be relatively long allows the distance Ld to be relatively short. As a result, the width along the X direction of the U shape can be e.g. less than λo/2, whereby the interval between the lateral portions 217T along the longitudinal direction can be made short.

An antenna device according to an example embodiment of the present disclosure can be suitably used in a radar device or a radar system to be incorporated in moving entities such as vehicles, marine vessels, aircraft, robots, or the like, for example. A radar device would include an antenna device according to an example embodiment of the present disclosure and a microwave integrated circuit that is connected to the antenna device. A radar system would include the radar device and a signal processing circuit that is connected to the microwave integrated circuit of the radar device.

The signal processing circuit may perform a process of estimating the azimuth of an arriving wave based on a signal that is received by a microwave integrated circuit, for example. For example, the signal processing circuit may be configured to execute the MUSIC method, the ESPRIT method, the SAGE method, or other algorithms to estimate the azimuth of the arriving wave, and output a signal indicating the estimation result. Furthermore, the signal processing circuit may be configured to estimate the distance to each target as a wave source of an arriving wave, the relative velocity of the target, and the azimuth of the target by using a known algorithm, and output a signal indicating the estimation result.

In the present disclosure, the term “signal processing circuit” is not limited to a single circuit, but encompasses any implementation in which a combination of plural circuits is conceptually regarded as a single functional part. The signal processing circuit may be realized by one or more System-on-Chips (SoC). For example, a part or a whole of the signal processing circuit may be an FPGA (Field-Programmable Gate Array), which is a programmable logic device (PLD). In that case, the signal processing circuit includes a plurality of computation elements (e.g., general-purpose logics and multipliers) and a plurality of memory elements (e.g., look-up tables or memory blocks). Alternatively, the signal processing circuit may be a set of a general-purpose processor(s) and a main memory device(s). The signal processing circuit may be a circuit which includes a processor core(s) and a memory device(s). These may function as the signal processing circuit.

An antenna device according to an example embodiment of the present disclosure includes a multilayered WRG structure which permits downsizing, and thus allows the area of the face on which antenna elements are arrayed to be significantly reduced, as compared to a construction in which a conventional hollow waveguide is used. Therefore, a radar system incorporating the antenna device can be easily mounted in a narrow place such as a face of a rearview mirror in a vehicle that is opposite to its specular surface, or a small-sized moving entity such as a UAV (an Unmanned Aerial Vehicle, a so-called drone). Note that, without being limited to the implementation where it is mounted in a vehicle, a radar system may be used while being fixed on the road or a building, for example.

An antenna device according to an example embodiment of the present disclosure can also be used in a wireless communication system. Such a wireless communication system would include an antenna device according to any of the above example embodiments and a communication circuit (a transmission circuit or a reception circuit). For example, the transmission circuit may be configured to supply, to a waveguide within the slot array antenna, a signal wave representing a signal for transmission. The reception circuit may be configured to demodulate a signal wave which has been received via the slot array antenna, and output it as an analog or digital signal.

An antenna device according to an example embodiment of the present disclosure can further be used as an antenna in an indoor positioning system (IPS). An indoor positioning system is able to identify the position of a moving entity, such as a person or an automated guided vehicle (AGV), that is in a building. An antenna device can also be used as a radio wave transmitter (beacon) for use in a system which provides information to an information terminal device (e.g., a smartphone) that is carried by a person who has visited a store or any other facility. In such a system, once every several seconds, a beacon may radiate an electromagnetic wave carrying an ID or other information superposed thereon, for example. When the information terminal device receives this electromagnetic wave, the information terminal device transmits the received information to a remote server computer via telecommunication lines. Based on the information that has been received from the information terminal device, the server computer identifies the position of that information terminal device, and provides information which is associated with that position (e.g., product information or a coupon) to the information terminal device.

Application examples of radar systems, communication systems, and various monitoring systems that include a slot array antenna having a WRG structure are disclosed in the specifications of U.S. Pat. Nos. 9,786,995 and 10,027,032, for example. The entire disclosure of these publications is incorporated herein by reference. A slot array antenna according to the present disclosure is applicable to each application example that is disclosed in these publications.

A waveguide device and antenna device according to the present disclosure is usable in any technological field that utilizes electromagnetic waves. For example, it is available to various applications where transmission/reception of electromagnetic waves of the gigahertz band or the terahertz band is performed. In particular, they may be suitably used in onboard radar systems, various types of monitoring systems, indoor positioning systems, wireless communication systems, etc., where downsizing is desired.

This application is based on Japanese Patent Applications No. 2018-142607 filed on Jul. 30, 2018, the entire contents of which are hereby incorporated by reference.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A waveguide device comprising:
a first electrical conductor including a first electrically conductive surface;
a second electrical conductor including a second electrically conductive surface opposing the first electrically conductive surface;
an electrically-conductive ridge protruding from the second electrically conductive surface, the ridge including a waveguide surface extending opposite to the first electrically conductive surface; and
a plurality of electrically-conductive rods disposed on both sides of the ridge, each including a root that is connected to the second electrically conductive surface and a leading end opposing the first electrically conductive surface; wherein
a waveguide is defined between the waveguide surface and the first electrically conductive surface;
the plurality of rods include one or more first rods adjoining the ridge;
each of the first rods includes a first side surface opposing a side surface of the ridge and a second side surface not opposing the side surface of the ridge;
the first side surface is flat and perpendicular or substantially perpendicular to the second electrically conductive surface;
the second side surface includes a shape that increasingly deviates outward from an axial center of the first rod from the leading end toward the root of the first rod; and
a distance from the axial center to the first side surface at the root is smaller than a distance from the axial center to the second side surface at the root.

2. The waveguide device of claim 1, wherein
the ridge includes at least one of a bend and a branching portion; and
the first side surface of at least one of the one or more first rods is opposed to a side surface of the ridge at the bend or the branching portion.

3. The waveguide device of claim 1, wherein
the second electrical conductor includes a throughhole leading to the waveguide defined between the waveguide surface and the first electrically conductive surface;
the plurality of rods include one or more second rods adjoining the throughhole;
each of the second rods includes a first side surface located on the throughhole side and a second side surface distinct from the first side surface; and
in each of the second rods:
the first side surface is flat and perpendicular or substantially perpendicular to the second electrically conductive surface;
the second side surface includes a shape that increasingly deviates outward from an axial center of the second rod from the leading end toward the root of the second rod; and
a distance from the axial center to the first side surface at the root is smaller than a distance from the axial center to the second side surface at the root.

4. The waveguide device of claim 1, wherein
the ridge includes at least one of a bend and a branching portion;
the first side surface of at least one of the one or more first rods is opposed to a side surface of the ridge at the bend or the branching portion;
the second electrical conductor includes a throughhole leading to the waveguide defined between the waveguide surface and the first electrically conductive surface;
the plurality of rods include one or more second rods adjoining the throughhole;
each of the second rods includes a first side surface located on the throughhole side and a second side surface distinct from the first side surface; and
in each of the second rods:
the first side surface is flat and perpendicular or substantially perpendicular to the second electrically conductive surface;
the second side surface includes a shape that increasingly deviates outward from an axial center of the second rod from the leading end toward the root of the second rod; and
a distance from the axial center to the first side surface at the root is smaller than a distance from the axial center to the second side surface at the root.

5. The waveguide device of claim 3, wherein
the plurality of rods include one or more third rods adjoining both of the ridge and the throughhole;
each of the third rods includes:
a first side surface opposing a side surface of the ridge;
a second side surface located on the throughhole side; and
a third side surface distinct from the first side surface and the second side surface; and
in each of the third rods:
each of the first side surface and the second side surface is flat and perpendicular or substantially perpendicular to the second electrically conductive surface;
the third side surface includes a shape that increasingly deviates outward from an axial center of the third rod from the leading end toward the root of the third rod; and
a distance from the axial center to the first side surface at the root is smaller than a distance from the axial center to the third side surface at the root.

6. The waveguide device of claim 1, wherein
the ridge is a first ridge;
the waveguide device further comprises an electrically-conductive second ridge spaced by a gap from the first ridge;
the second ridge protrudes from the second electrically conductive surface and includes a waveguide surface extending opposite to the first electrically conductive surface, a waveguide being defined between the waveguide surface and the first electrically conductive surface;
the plurality of rods include one or more rod rows located between the first ridge and the second ridge;
at least one rod included in the one or more rod rows includes:
a first side surface opposing a side surface of the first ridge or the second ridge; and
a second side surface opposing neither the side surface of the first ridge nor the side surface of the second ridge;
the first side surface is flat and perpendicular or substantially perpendicular to the second electrically conductive surface; and
the second side surface includes a shape that increasingly deviates outward from an axial center of the rod from the leading end toward the root of the rod.

7. The waveguide device of claim 1, wherein
the second electrical conductor includes a throughhole leading to the waveguide defined between the waveguide surface and the first electrically conductive surface;
the plurality of rods include one or more second rods adjoining the throughhole;
each of the second rods includes a first side surface located on the throughhole side and a second side surface distinct from the first side surface;
in each of the second rods:
the first side surface is flat and perpendicular or substantially perpendicular to the second electrically conductive surface;
the second side surface includes a shape that increasingly deviates outward from an axial center of the second rod from the leading end toward the root of the second rod; and
a distance from the axial center to the first side surface at the root is smaller than a distance from the axial center to the second side surface at the root;
the ridge is a first ridge;
the waveguide device further includes an electrically-conductive second ridge located at a gap from the first ridge;
the second ridge protrudes from the second electrically conductive surface and includes a waveguide surface extending opposite to the first electrically conductive surface, a waveguide being defined between the waveguide surface and the first electrically conductive surface;
the plurality of rods include one or more rod rows located between the first ridge and the second ridge;
at least one rod included in the one or more rod rows includes:
a first side surface opposing a side surface of the first ridge or the second ridge; and
a second side surface opposing neither the side surface of the first ridge nor the side surface of the second ridge;
the first side surface is flat and perpendicular or substantially perpendicular to the second electrically conductive surface; and
the second side surface includes a shape that increasingly deviates outward from an axial center of the rod from the leading end toward the root of the rod.

8. The waveguide device of claim 3, wherein
the plurality of rods include one or more third rods adjoining both of the ridge and the throughhole;
each of the third rods includes:
a first side surface opposing a side surface of the ridge;
a second side surface located on the throughhole side; and
a third side surface distinct from the first side surface and the second side surface; and
in each of the third rods:
each of the first side surface and the second side surface is flat and perpendicular or substantially perpendicular to the second electrically conductive surface;
the third side surface includes a shape that increasingly deviates outward from an axial center of the third rod from the leading end toward the root of the third rod; and
a distance from the axial center to the first side surface at the root is smaller than a distance from the axial center to the third side surface at the root;
the ridge is a first ridge;
the waveguide device further comprises an electrically-conductive second ridge spaced by a gap from the first ridge;
the second ridge protrudes from the second electrically conductive surface and includes a waveguide surface extending opposite to the first electrically conductive surface, a waveguide being defined between the waveguide surface and the first electrically conductive surface;
the plurality of rods include one or more rod rows located between the first ridge and the second ridge;
at least one rod included in the one or more rod rows includes:
a first side surface opposing a side surface of the first ridge or the second ridge; and
a second side surface opposing neither the side surface of the first ridge nor the side surface of the second ridge;
the first side surface is flat and perpendicular or substantially perpendicular to the second electrically conductive surface; and
the second side surface includes a shape that increasingly deviates outward from an axial center of the rod from the leading end toward the root of the rod.

9. The waveguide device of claim 6, wherein
the one or more rod rows located between the first ridge and the second ridge consists of one rod row; and
regarding side surfaces of each rod in the rod row, a side surface opposing the side surface of the first ridge and a side surface opposing the side surface of the second ridge are each flat and perpendicular or substantially perpendicular to the second electrically conductive surface, and any other side surface includes a shape that increasingly deviates outward from the axial center of the rod from the leading end toward the root of the rod.

10. A waveguide device comprising:
a first electrical conductor including a first electrically conductive surface;
a second electrical conductor including a second electrically conductive surface opposing the first electrically conductive surface and a waveguide functioning as a throughhole; and
a plurality of electrically-conductive rods each including a root that is connected to the second electrically conductive surface and a leading end opposing the first electrically conductive surface; wherein
the plurality of rods include one or more rods adjoining the throughhole;
each of the one or more rods includes a first side surface located on the throughhole side and a second side surface distinct from the first side surface;
the first side surface is flat and perpendicular or substantially perpendicular to the second electrically conductive surface; and
the second side surface includes a shape that increasingly deviates outward from an axial center of the rod from the leading end toward the root of the rod.

11. The waveguide device of claim 1, wherein
at least a portion of the second electrical conductor, the ridge, and the plurality of rods includes a dielectric body that defines a shape of the at least portion of the second electrical conductor, the ridge, and the plurality of rods, and a layer of electrically conductive material covering a surface of the dielectric body.

12. The waveguide device of claim 10, wherein
at least a portion of the second electrical conductor, the ridge, and the plurality of rods includes a dielectric body that defines a shape of the at least portion of the second electrical conductor, the ridge, and the plurality of rods, and a layer of electrically conductive material covering a surface of the dielectric body.

13. The waveguide device of claim 1, wherein at least one of the plurality of rods includes a side surface with an angle of inclination relative to a normal of the second electrically conductive surface that changes in two or more steps.

14. The waveguide device of claim 3, wherein
at least one of the plurality of rods includes a side surface with an angle of inclination relative to a normal of the second electrically conductive surface that changes in two or more steps;
the plurality of rods include one or more third rods adjoining both of the ridge and the throughhole;
each of the third rods includes:
a first side surface opposing a side surface of the ridge;
a second side surface located on the throughhole side; and
a third side surface distinct from the first side surface and the second side surface; and
in each of the third rods:
each of the first side surface and the second side surface is flat and perpendicular or substantially perpendicular to the second electrically conductive surface;
the third side surface includes a shape that increasingly deviates outward from an axial center of the third rod from the leading end toward the root of the third rod; and
a distance from the axial center to the first side surface at the root is smaller than a distance from the axial center to the third side surface at the root.

15. The waveguide device of claim 14, wherein
the at least one rod including a side surface with an angle of inclination that changes in two or more steps adjoins the ridge or the throughhole on the second electrical conductor;
the side surface does not face toward the ridge or the throughhole; and
regarding the changing angle of inclination of the side surface relative to the normal of the second electrically conductive surface, a largest angle is greater than an angle of inclination of a side surface of the rod that faces toward the ridge or the throughhole relative to the normal of the second electrically conductive surface.

16. An antenna device comprising:
the waveguide device of claim 1; and
one or more antenna elements connected to the waveguide device.

17. A radar device comprising:
the antenna device of claim 16; and
a microwave integrated circuit connected to the antenna device.
